(19) United States
(12) Patent Application Publication
(10) Pub. No.: US 2012/0244331 A1
(43) Pub. Date: Sep. 27, 2012

(54) CELLULOSE ACYLATE FILM AND ITS PRODUCTION METHOD, POLARIZER AND LIQUID CRYSTAL DISPLAY DEVICE

(75) Inventors: Shinya WATANABE, Kanagawa (JP); Nobutaka FUKAGAWA, Kanagawa (JP); Yu NAITO, Kanagawa (JP); Jun TAKEDA, Kanagawa (JP); Akiko WATANO, Kanagawa (JP)

(73) Assignee: FUJIFILM CORPORATION, Tokyo (JP)

(21) Appl. No.: 13/428,646

(22) Filed: Mar. 23, 2012

(30) Foreign Application Priority Data
Mar. 25, 2011 (JP) 2011-068452
Jul. 29, 2011 (JP) 2011-167532

(51) Int. Cl. B32B 3/00; G02B 5/30; B32B 23/04

(52) U.S. Cl. 428/220; 428/534; 252/585

(57) ABSTRACT

A cellulose acylate film containing a cellulose acylate and an organic acid represented by X-L-(R¹)ₙ in an amount of 0.01-1% by mass of the cellulose acylate, wherein at least 90% by mass of the cellulose acylate is a cellulose acylate having a total degree of acyl substitution of 1.5-2.7. In the formula, X represents an acid group having an acid dissociation constant of at most 5.5, L represents a single bond or a lining group having two or more valence, and R⁻ represents a hydrogen atom, an alkyl group, etc.

### CROSS-REFERENCE TO RELATED APPLICATIONS

The present application claims the benefit of priority from Japanese Patent Application No. 2011-68452 filed on Mar. 25, 2011 and Japanese Patent Application No. 2011-167532 filed on Jul. 29, 2011, the contents of which are herein incorporated by reference in their entirety.

### BACKGROUND OF THE INVENTION

1. Field of the Invention

The present invention relates to a cellulose acylate film and its production method, and to a polarizer and a liquid crystal display device using the cellulose acylate film.

2. Description of the Related Art

With the recent tendency toward advancing TV use of liquid crystal display devices, the panel size of the devices is enlarged and high-definition and low-price liquid crystal display devices are much desired. In addition, for broadening the viewing angle and for reducing the color shift in liquid crystal display devices, used is a retardation film having a specific retardation value as well as a combination with such a retardation film.

It is known that, as the main starting material for the retardation film of the type, cellulose acylate is advantageous and that the optical properties of the film depend on the degree of acyl substitution of the cellulose acylate. In particular, a cellulose acylate having a low degree of substitution has a high intrinsic birefringence, and therefore it is considered that, by reducing the degree of acyl substitution thereof, the cellulose acylate of the type could realize high optical expressibility suitable, for example, for retardation film for VA-mode devices. However, reducing the degree of acyl substitution brings about various problems in the process of film formation of cellulose acylate films, and therefore the cellulose acylate having such a lowered degree of acyl substitution could not heretofore have broad applications in practical use. Concretely, it is known that, when a cellulose acylate having a lowered degree of acyl substitution is cast for film formation, the peelability of the film from the support worsens, and therefore, the film could hardly be peeled, or even though the film could be peeled, there may occur a problem in that the formed film often have streaks in the surface thereof running in the direction perpendicular to the machine direction while peeled from the support.

Patent Reference 1 says that, when a layer having a high degree of acyl substitution (of which the total degree of acyl substitution is more than 2.7) is provided as the support-facing layer of a cellulose acylate film having a low degree of acyl substitution (of from more than 2.0 to less than 2.8) and having poor peelability from support, then the peelability from support of the film can be enhanced.

Patent Reference 2 describes a method of casting a cellulose acylate film solution for film formation wherein the solution contains an acid or an alkali metal salt or alkaline earth metal salt thereof having an acid dissociation index in an aqueous solution of from 1.93 to 4.50. The patent reference describes use of such an organic acid or an inorganic acid satisfying the condition as a peeling agent. In Examples in the patent reference, used is the compound 6 (organic sodium phosphate salt in which an alkyl group having 12 carbon atoms and an alkyl group having 10 carbon atoms bond to the phosphoric acid group) and the compound 9 (organic potassium sulfonate salt in which an alkyl group having 16 carbon atoms bonds to the sulfonic acid group via a linking group of an aryleneoxy group and an alkylene group) described in JP-A 61-243837, as the peeling agent for a cellulose acylate having a total degree of acyl substitution of from 2.7 to 2.9.

### CITATION LIST

Patent Reference 1: JP-A 2010-58331

Patent Reference 2: JP-A 2002-179838

However, as a result of investigations, the present inventors have found that, in case where a layer having a high degree of acyl substitution is provided on the side nearer to the support than the side of the layer having a low degree of substitution, as in Patent Reference 1, and when the content of the layer having a high degree of acyl substitution increases relative to the content of the layer of having a low degree of acyl substitution, then the film may whiten in reusing it since the layers are immiscible with each other so that the recyclability of the film is poor. From the recent viewpoint of environmental load reduction in the art, it is desired to effectively recycle film chips; however, it has been known that, when the layer having a high degree of acyl substitution is thinned in order to lower the content of the content of the layer having a high degree of acyl substitution relative to the content of the layer having a low degree of substitution, then the layer interface is disordered so that the layer on the support side could hardly be formed uniformly and the surface condition of the film worsens and the production yield of the film is thereby lowered. In addition, it has also been known that, when a large amount of an organic acid or an inorganic acid is added to a cellulose acylate having a low degree of substitution, as in Patent Reference 2, then the peelability of film from support could be enhanced but the finished film is whitened.

Further, it has been known that, when the organic acid or the inorganic acid described in Patent Reference 2 is used, then there occurs another problem of corrosion of production plants.

### SUMMARY OF THE INVENTION

The invention has been made in consideration of the situation as above, and its object is to provide a thinner cellulose acylate film improved in point of the peelability thereof from support in solution-casting film formation, excellent in transparency, excellent in optical expressibility and excellent in film recyclability, to provide a method for producing the cellulose acylate film at high production yield and at low production equipment maintenance cost. Another object is to provide a polarizer and a liquid crystal display device using the cellulose acylate film.

The present inventors have assiduously studied for the purpose of solving the above-mentioned problems and, as a result, have found that, when a cellulose acylate having a low degree of acyl substitution is first used, a layer having a low degree of acyl substitution and containing, as added thereto as a peeling agent, an organic acid having an acid group moiety and, in addition to the moiety, a hydrophobic group having a specific structure is provided as a thin layer on the support side, and no organic acid is added to the other layer having a low degree of acyl substitution is added, then the film peelability from support is enhanced in solution-casting cellulose acylate film formation, and the cellulose acylate film produced has high optical expressibility and transparency and is excellent in film recyclability.

Further, the inventors have found that, even in an embodiment where different cellulose acylate solutions are cast to form a two-layer film and where the compositions of the solutions are so designed that the total degree of acyl substitution of the cellulose acylate in the layer of the film having a low degree of acyl substitution and containing, as added thereto as a peeling agent, an organic acid having an acid group moiety and, in addition to the moiety, a hydrophobic group having a specific structure is controlled to be nearly equal to the total degree of acyl substitution of the cellulose acylate in the layer thereof having a low degree of acyl substitution and not containing the organic acid so that the two layers are miscible in such a degree that the interface between the layers of the formed film could not be clearly discriminated, the cellulose acylate film capable of completely solving the above-mentioned problems can be obtained only when the organic acid is added to the layer on the support side in solution-casting film formation.

In addition, the inventors have found that use of the organic acid having an acid group moiety and, in addition to the moiety, a hydrophobic group having a specific structure enhances the film peelability from support in solution-casting film formation and additionally prevents the corrosion of production plants that is the negative effect in using organic acid, and as a result have found the production method for cellulose acylate film of the invention having advantages of high production yield and low production equipment maintenance cost. Specifically, the above-mentioned problems can be solved by the following means.
[1] A cellulose acylate film containing a cellulose acylate and an organic acid represented by the following general formula (1) in an amount of from 0.01% by mass to less than 1% by mass of the cellulose acylate, wherein at least 90% by mass of the cellulose acylate is a cellulose acylate having a total degree of acyl substitution of from 1.5 to 2.7:

X-L-(R¹)ₙ (1)

wherein X represents an acid group having an acid dissociation constant of at most 5.5; L represents a single bond or a lining group having two or more valence; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms, or a heterocyclic group having from 6 to 30 carbon atoms, which may be further substituted; n is 1 when L is a single bond but is (the valence of L-1) when L is a lining group having two or more valence.
[2] The cellulose acylate film of [1], wherein X in the general formula (1) has at least one of a carboxyl group, a sulfonic acid group, a sulfinic acid group, a phosphoric acid group, a sulfonimide group and an ascorbic acid group.
[3] The cellulose acylate film of [1] or [2], wherein L in the general formula (1) is a single bond, or a lining group having two or more valence selected from the following groups or a combination of these groups:
Groups: —O—, —CO—, —N(R²)— (where R² represents an alkyl group having from 1 to 5 carbon atoms), —CH (OH)—, —CH₂—, —CH═CH—, —SO₂—.
[4] The cellulose acylate film of any one of [1] to [3], wherein the organic acid represented by the general formula (1) has a structure where one molecule of a fatty acid and one molecule of a polycarboxylic acid bond to one molecule of a polyalcohol via ester-bonding, and has at least one unsubstituted carboxyl group derived from the polycarboxylic acid.
[5] The cellulose acylate film of any one of [1] to [4], wherein one face of the cellulose acylate film is called a face A and the other face thereof is a face B, and wherein the content of the organic acid existing in the depth of up to 2 μm from each surface of the face A and the face B, relative to the cellulose acylate, satisfies the following formula (I):

0.85≦Xa/Xb≦1.0 (I)

Xa≦Xb (I′)

wherein Xa means the organic acid content in the depth of up to 2 μm from the surface of the face A; and Xb means the organic acid content in the depth of up to 2 μm from the surface of the face B.
[6] The cellulose acylate film of any one of [1] to [5], which is formed through simultaneous or successive multilayer casting on a support and in which the organic acid is added to only the cellulose acylate solution to form the layer kept in contact with the support in casting.
[7] The cellulose acylate film of any one of [1] to [6], which has a total haze of at most 1% and has an internal haze of at most 0.1%.
[8] The cellulose acylate film of any one of [1] to [7], which has a thickness of from 20 to 60 μm.
[9] A method for producing a cellulose acylate film, which comprises (1) preparing a solution for core layer containing a cellulose acylate (in which the content of the organic acid represented by the following general formula (1) is at most 3% by mass of the cellulose acylate) and a solution for support-side layer containing a cellulose acylate and an organic acid represented by the following general formula (1) in an amount of from 0.1% by mass to 20% by mass of the cellulose acylate, (2) simultaneously or successively multilayer-casting the core layer solution and the support-side layer solution prepared in (1), onto a support, (3) drying the solution multilayer-cast in (2) on the support and then peeling it from the support, and (4) stretching the film as peeled in (3), wherein at least 90% by mass of the cellulose acylate contained in the core layer solution and the support-side layer solution has a total degree of acyl substitution of from 1.5 to 2.7, and the core layer solution and the support-side layer solution are so controlled that the casting thickness of the support-side layer solution is at least 0.5% of the total casting thickness of the core layer solution and the support-side layer solution:

X-L-(R¹)ₙ (1)

wherein X represents an acid group having an acid dissociation constant of at most 5.5; L represents a lining group having two or more valence; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms, or a heterocyclic group having from 6 to 30 carbon atoms, which may be further substituted; n is 1 when L is a single bond but is (the valence of L-1) when L is a lining group having two or more valence.
[10] A method for producing a cellulose acylate film, which comprises (A) preparing a solution containing a cellulose acylate, (B) preparing a solution of an organic acid represented by the following general formula (1), (C) applying the organic acid solution prepared in (B) onto a support in such a manner that the amount of the organic acid could be from 0.001 mg/cm² to 0.8 mg/cm², (D) casting the solution prepared in (A) onto the layer formed by applying the organic acid solution to the support in (C), (E) drying the cellulose acylate solution cast in (D), on the support and peeling it from the support, and (F) stretching the film peeled in (E), wherein at least 90% by mass of the cellulose acylate has a total degree of acyl substitution of from 1.5 to 2.7:

X-L-(R¹)ₙ (1)

wherein X represents an acid group having an acid dissociation constant of at most 5.5; L represents a single bond or a lining group having two or more valence; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms, or a heterocyclic group having from 6 to 30 carbon atoms, which may be further substituted; n is 1 when L is a single bond but is (the valence of L-1) when L is a lining group having two or more valence.
[11] The method for producing a cellulose acylate film of any one of [9] or [10], wherein X in the general formula (1) has at least one of a carboxyl group, a sulfonic acid group, a sulfinic acid group, a phosphoric acid group, a sulfonimide group and an ascorbic acid group.
[12] The method for producing a cellulose acylate film of any one of [9] to [11], wherein L in the general formula (1) is a single bond, or a lining group having two or more valence selected from the following groups or a combination of these groups:
Groups: —O—, —CO—, —N(R²)— wherein R² represents an alkyl group having from 1 to 5 carbon atoms, —CH(OH)—, —CH₂—, —CH═CH—, —SO₂—.
[13] The method for producing a cellulose acylate film of any one of [9] to [12], wherein the organic acid represented by the general formula (1) has a structure where one molecule of a fatty acid and one molecule of a polycarboxylic acid one molecule bond to one molecule of a polyalcohol via ester-bonding, and has at least one unsubstituted carboxyl group derived from the polycarboxylic acid.
[14] A cellulose acylate film produced according to the cellulose acylate production method of any one of [9] to [13].
[15] A polarizer containing at least one cellulose acylate film of any one of [1] to [8] and [14].
[16] A liquid crystal display device containing at least one of the cellulose acylate film of any one of [1] to [8] and [14] or the polarizer of [15].

According to the invention, there is provided a cellulose acylate film improved in point of the peelability thereof from metal support in solution-casting film formation, having high optical expressibility and transparency and excellent in film recyclability, and there is also provided a method for producing the cellulose acylate film at high production yield and at low production equipment maintenance cost. Further according to the invention, there is provided a polarizer using the cellulose acylate film and having high polarizer durability. Also provided is a liquid crystal display devices improved in durability in high-temperature and high-humidity environments by incorporating the polarizer using the cellulose acylate film into the device.

### BRIEF DESCRIPTION OF THE DRAWING

FIG. 1 is a schematic cross-sectional view showing one example of the liquid crystal display device of the invention.

FIG. 2 is a schematic view showing one example of a simultaneous co-casting method using a co-casting die for producing a three-layer laminate cellulose acylate film by casting.

### BEST MODE FOR CARRYING OUT THE INVENTION

The cellulose acylate film and its production method of the invention and additives to be used for the film and the method are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### [Cellulose Acylate Film]

The cellulose acylate film of the present invention (hereinafter this maybe referred to as the film of the present invention) contains a cellulose acylate and an organic acid represented by the following general formula (1) in an amount of from 0.01% by mass to less than 1% by mass of the cellulose acylate, wherein at least 90% by mass of the cellulose acylate is a cellulose acylate having a total degree of acyl substitution of from 1.5 to 2.7:

X-L-(R¹)ₙ (1)

wherein X represents an acid group having an acid dissociation constant of at most 5.5; L represents a single bond or a lining group having two or more valence; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms, or a heterocyclic group having from 6 to 30 carbon atoms, which may be further substituted; n is 1 when L is a single bond but is (the valence of L-1) when L is a lining group having two or more valence.

The invention is described concretely with reference to preferred embodiments of the present invention mentioned below.

### <Cellulose Acylate>

The starting cellulose for the cellulose acylate includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8; and cellulose materials described in these may be used here.

The cellulose acylate for the film of the present invention may have only one type of an acyl group, or two or more different types of acyl groups. Preferably, the film of the present invention has an acyl group having from 2 to 4 carbon atoms as the substituent. In case where the cellulose acylate has two or more different types of acyl groups, preferably, one of them is an acetyl group. The acyl group having from 2 to 4 carbon atoms is preferably a propionyl group or a butyryl group. The cellulose acylate may form a solution of good solubility, and especially in a non-chlorine organic solvent, it may form a good solution. In particular, a solution having a low viscosity and good filterability can be produced.

The cellulose acylate preferably used in the present invention is described in detail. The β-1,4-bonding glucose unit to constitute cellulose has a free hydroxyl group at the 2-, 3- and 6-positions. The cellulose acylate is a polymer produced by esterifying a part or all of those hydroxyl groups in cellulose with an acyl group. The degree of acyl substitution means the total of the ratio of esterification of the hydroxyl group in cellulose positioned in the 2-, 3- and 6-positions in the unit therein. In case where the hydroxyl group is 100% esterified at each position, the degree of substitution at that position is 1.

In the present invention, at least 90% by mass of the cellulose acylate has a total degree of acyl substitution of from 1.5 to 2.7, preferably from 1.6 to 2.6, more preferably from 2.0 to 2.5. The cellulose acylate having a low degree of substitution is inexpensive and is excellent in optical properties, however, when it is formed into a film according to an ordinary solution casting method, the film poorly peels from metal support, and consequently the cellulose acylate of the type has heretofore been not used so much in the art. In the present invention, the organic acid represented by the above-mentioned general formula (1) is used in forming the film of the present invention according to a solution-casting method, and accordingly, such an inexpensive cellulose acylate can be favorably used here.

In the present invention, more preferably, at least 90% by mass of the cellulose acylate satisfied the above-mentioned range of the total degree of acyl substitution, even more preferably at least 95% by mass thereof satisfies the range of the total degree of acyl substitution, still more preferably at least 96% by mass thereof satisfies the range of the total degree of acyl substitution, and especially preferably all the cellulose acylate satisfies the range of the total degree of acyl substitution.

The acyl group having 2 or more carbon atoms in the cellulose acylate may be an aliphatic group or an aryl group with no specific limitation thereon. For example, it includes cellulose alkylcarbonyl esters, alkenylcarbonyl esters, aromatic carbonyl esters, aromatic alkylcarbonyl esters, etc., and these may have a substituent group. As their preferred, there may be mentioned an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group, a cinnamoyl group, etc. Of those, preferred are an acetyl group, a propionyl group, a butanoyl group, a dodecanoyl group, an octadecanoyl group, a tert-butanoyl group, an oleoyl group, a benzoyl group, a naphthylcarbonyl group, a cinnamoyl group, etc.; more preferred are an acetyl group, a propionyl group and a butanoyl group (acyl groups each having from 2 to 4 carbon atoms); and even more preferred is an acetyl group (the cellulose acylate is cellulose acetate).

In case where an acid hydride or an acid chloride is used as the acylating agent for acylation of cellulose, the reaction solvent of an organic solvent to be used includes an organic acid, for example, acetic acid, methylene chloride, etc.

In case where the acylating agent is an acid anhydride, the catalyst to be used is preferably a protic catalyst such as sulfuric acid; and in case where the acylating agent is an acid chloride (for example, CH₃CH₂COCl), a basic compound is preferably used.

A most general method for industrial production of mixed fatty acid esters of cellulose comprises acylating cellulose with a mixed organic acid component containing a fatty acid corresponding to an acetyl group or any other acyl group (acetic acid, propionic acid, valeric acid, etc.), or an acid anhydride thereof.

The cellulose acylate for use in the invention can be produced, for example, according to the method described in JP-A 10-45804.

### <Organic Acid>

### (Structure of Organic Acid Represented by General Formula (1))

The film of the present invention contains an organic acid represented by the above-mentioned general formula (1).

X-L-(R¹)ₙ (1)

wherein X represents an acid group having an acid dissociation constant of at most 5.5; L represents a single bond or a lining group having two or more valence; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms, or a heterocyclic group having from 6 to 30 carbon atoms, which may be further substituted; n is 1 when L is a single bond but is (the valence of L-1) when L is a lining group having two or more valence.

Not adhering to any theory, it is considered that the hydroxyl group in cellulose acylate interacts with support via the metal ion in the solvent or the cellulose acylate and therefore, when the cellulose acylate having a degree of acyl substitution of from 1.5 to 2.7 as in the present invention is used, then the peelability of the formed film from support would worsen. The organic acid represented by the above-mentioned general formula (1) has a hydrophilic group moiety and a hydrophobic group moiety, and is therefore considered to have an effect like surfactant to thereby enhance the film peelability from support.

In the organic acid represented by the above-mentioned general formula (1), the acid group of the moiety X acts to enhance the peelability in solution-casting film formation (the film peelability from the support onto which dope is cast).

Further, the acid group of the moiety X adheres to the metal surface of a support and the hydrophobic group moiety of the above-mentioned group R¹ having a specific structure acts to block the metal surface of the support from an oxidizing agent such as oxygen or the like, and therefore, as compared with any other organic acid having a hydrophobic group falling outside the range of the above-mentioned R¹, the organic acid of the type in the present invention can prevent the corrosion of metal.

The peeling promoter usable in the film of the present invention is described below.

In the general formula (1), X represents an acid group having an acid dissociation constant of at most 5.5, and is preferably a carboxyl group, a sulfonic acid group, a sulfinic acid group, a phosphoric acid group, a sulfonimide group or an ascorbic acid group, more preferably a carboxyl group or a sulfonic acid group, and most preferably a carboxyl group. In case where X is an ascorbic acid group, preferably, the hydrogen atoms in the 5- and 6-positions of those in ascorbic acid are removed and the residue links with L in the formula.

In this description, as the acid dissociation constant, employed is the value described in Chemical Handbook published by Maruzen.

In the general formula (1), R¹ represents a hydrogen atom, an alkyl group having from 6 to 30 carbon atoms (and optionally having a substituent), an alkenyl group having from 6 to 30 carbon atoms (and optionally having a substituent), an alkynyl group having from 6 to 30 carbon atoms (and optionally having a substituent), an aryl group having from 6 to 30 carbon atoms (and optionally having a substituent), or a heterocyclic group having from 6 to 30 carbon atoms (and optionally having a substituent). The substituent includes a halogen atom, an aryl group, a heterocyclic group, an alkoxy group, an aryloxy group, an alkylthio group, an arylthio group, an acyl group, a hydroxyl group, an acyloxy group, an amino group, an alkoxycarbonyl group, an acylamino group, an oxycarbonyl group, a carbamoyl group, a sulfonyl group, a sulfamoyl group, a sulfonamide group, a sulforyl group, a carboxyl group, etc.

Preferably, R¹ is an alkyl, alkenyl or alkynyl group having from 8 to 24 carbon atoms, most preferably a linear alkyl or alkenyl group having from 10 to 24 carbon atoms.

L in the general formula (1) is preferably a single bond, or a lining group having two or more valence selected from the following groups or a combination of these groups:
Groups: —O—, —CO—, —N(R²)— (where R² represents an alkyl group having from 1 to 5 carbon atoms), —CH(OH)—, —CH₂—, —CH═CH—, —SO₂—.

L in the general formula (1) preferably has a single bond, an ester group-derived linking group (—COO—, —OCO—), or an amide group-derived linking group (—CONR²—, —NR²CO—) as a partial structure thereof.

L may further have a substituent, and the substituent is not specifically defined. For the substituent, for example, there are mentioned those that the above-mentioned R¹ may have. Above all, preferred is an —OH group.

Among the above, L is more preferably a linking group that contains a glycerin-derived group.

Concretely, preferred examples of the structure of L are as mentioned below. In the following, p, q and r each indicate an integer of from 1 to 40, preferably from 1 to 20, more preferably from 1 to 10, even more preferably from 1 to 6. q is especially preferably from 2 to 4.
—(CH₂)ₚ—CO—O—(CH₂)_{q}—O—;
—(CH₂)ₚ—CO—O—(CH₂)_{q}—(CH(OH))—(CH₂)ᵣ—O—;
—(CH₂)ₚ—CO—O—(CH₂)_{q}—(CH(OCO—R³))—(CH₂)ᵣ—O—;
—(CH₂)ₚ—CO—O—(CH₂)_{q}—(CH(OH))—(CH₂)ᵣ—O—CO—;
—(CH₂)ₚ—CO—O—(CH₂)_{q}—(CH(OCO—R³))—(CH₂)ᵣ—O—CO—.

R³ contained in the above-mentioned examples of L has the same meaning as R¹ in the above-mentioned general formula (1). Specifically, R³ in the linking group of —(CH₂)ₚ'CO—O—(CH₂)_{q}—(CH(OCO—R³))—(CH₂)ᵣ—O— is shown inside L for convenience sake, and the linking group L means the part except R³. In other words, in this case, L is trivalent. When expressed by the general formula (1) it is expressed by X-L-(R¹)₂, [where L represents —(CH₂)ₚ—CO—O—(CH₂)_{c}—(CH(OCO—))—(CH₂)ᵣ—O—], or that is, the linking group L in this case is a trivalent linking group.

Preferably, L and X bond to each other via an ester bond or an amide bond, more preferably via an ester bond. Also preferably, neither an ester bond nor an amide bond exists in X.

Preferably, L and R¹ bond to each other via an ester bond, an ether bond or an amide bond, more preferably via an ester bond or an amide bond, even more preferably via an ester bond. Also preferably, neither ester bond nor amide bond exists in R¹.

Preferred examples of the organic acid represented by the general formula (1) usable in the present invention are shown below.

### <<Fatty Acid>>

Myristic acid, palmitic acid, stearic acid, oleic acid, linolic acid, linolenic acid, recinoleic acid, undecanoic acid.

### <<Alkylsulfuric Acid>>

Myristylsulfuric acid, cetylsulfuric acid, oleylsulfuric acid.

### <<Alkylbenzenesulfonic Acid>>

Dodecylbenzenesulfonic acid, pentadecylbenzenesulfonic acid.

### <<Alkylnaphthalenesulfonic Acid>>

Sesquibutylnaphthalenesulfonic acid, diisobutylnaphthalenesulfonic acid.

### <<Dialkylsulfosuccinic Acid>>

Dioctylsulfosuccinic acid, dihexylsulfosuccinic acid, dicyclohexylsulfosuccinic acid, diamylsulfosuccinic acid, ditridecylsulfosuccinic acid.

### <<Partial Derivative of Polyhydric Organic Acid>>

Preferably, the organic acid represented by the above-mentioned general formula (1) is a partial derivative of a polyhydric organic acid. In this description, the partial derivative of a polyhydric organic acid is a compound which has a structure where one molecule of a fatty acid and a polyhydric organic acid bond to one molecule of a polyalcohol via ester-bonding, and has at least one unsubstituted acid group derived from a polycarboxylic acid. In this description, the fatty acid means an aliphatic monocarboxylic acid. Specifically, the fatty acid in this description is not limited to a higher fatty acid alone but includes a lower fatty acid having at most 12 carbon atoms such as acetic acid and propionic acid.

The partial derivative of the polyhydric organic acid is preferably a partial derivative of a polycarboxylic acid. Specifically, it is desirable that the organic acid represented by the above-mentioned general formula (1) has a structure where one molecule of a fatty acid and one molecule of a polycarboxylic acid bond to one molecule of a polyalcohol via ester-bonding, and has at least one unsubstituted carboxyl group derived from the polycarboxylic acid. Not specifically defined, the polycarboxylic acid for use in the partial derivative of a polycarboxylic acid is, for example, preferably succinic acid, citric acid, tartaric acid, diacetyltartaric acid, malic acid or adipic acid.

The polyalcohol for use in the partial derivative of a polycarboxylic acid includes adonitol, arabitol, ethylene glycol, diethylene glycol, triethylene glycol, tetraethylene glycol, 1,2-propanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, glycerin, etc. Of those, preferred is glycerin. Therefore, the organic acid represented by the above-mentioned general formula (1) for use in the invention is preferably an organic acid glyceride.

Preferably, the organic acid represented by the above-mentioned general formula (1) for use in the invention is an organic acid glyceride in which the acid group L of the organic acid bonds to the hydrophobic moiety R¹ via the linking group L that contains a glycerin-derived group (glycerin fatty acid organic acid ester). Here in this description, the organic acid glyceride is meant to indicate a compound in which one or two of the three hydroxyl groups of glycerin form an ester bond with a fatty acid and one or two of the remaining hydroxyl groups form an ester bond with a polyhydric organic acid, and which has a structure having an acid group derived from the polyhydric organic acid.

Above all, preferred are organic acid monoglycerides or organic acid diglycerides, and more preferred are organic acid monoglycerides. The organic acid monoglyceride in this description is meant to indicate a compound in which one of the three hydroxyl groups of glycerin forms an ester bond with a fatty acid and one or two of the remaining hydroxyl groups form an ester bond with a polyhydric organic acid, and which has a structure having an acid group derived from the polyhydric organic acid. The organic acid diglyceride in this description is meant to indicate a compound in which two of the three hydroxyl groups of glycerin form an ester bond with a fatty acid and the remaining one hydroxyl group forms an ester bond with a polyhydric organic acid, and which has a structure having an acid group derived from the polyhydric organic acid.

Of the above-mentioned organic acid monoglycerides, even more preferred are compounds in which one of the three hydroxyl groups of glycerin forms an ester bond with a fatty acid, one of the remaining hydroxyl groups is an unsubstituted hydroxyl group and the other remaining hydroxyl group forms an ester bond with a polyhydric organic acid, and which has a structure having an acid group derived from the polyhydric organic acid. The hydroxyl group bonding to the fatty acid of the organic fatty acid monoglyceride via ester-bonding is preferably in an asymmetric position (that is, in a so-called a-monoglyceride position); and the hydroxyl group bonding to the polyhydric organic acid of the organic acid monoglyceride via ester-bonding is also preferably in an asymmetric position (that is, in a so-called a-monoglyceride position). Specifically, of the above-mentioned organic acid monoglycerides, more preferred are compounds having an unsubstituted hydroxyl group and having a structure in which the carbon atom directly bonding to the hydroxyl group that bonds to the fatty acid via ester-bonding and the carbon atom directly bonding to the hydroxyl group that bonds to the polyhydric organic acid via ester-bonding are not positioned to be adjacent to each other.

Of the above-mentioned organic acid monoglycerides, especially preferred are monoglycerides of polycarboxylic acids. The monoglyceride of a polycarboxylic acid means an organic acid in which at least one carboxyl group of the polycarboxylic acid is an unsubstituted carboxyl group and the other carboxyl groups are substituted with a monoglyceride. Specifically, preferred for use herein is a carboxyl group-containing organic acid monoglyceride in which one molecule of a fatty acid and one molecule of a polycarboxylic acid bond to one molecule of glycerin.

Not specifically defined, the polycarboxylic acid for use in the polycarboxylic acid monoglyceride is, for example, preferably succinic acid, citric acid, tartaric acid, diacetyltartaric acid, malic acid, or adipic acid.

Also not specifically defined, the fatty acid for use in the polycarboxylic acid monoglyceride is preferably a saturated or unsaturated fatty acid having from 8 to 22 carbon atoms, concretely caprylic acid, capric acid, lauric acid, myristic acid, palmitic acid, stearic acid, behenic acid, oleic acid, etc.

The carboxyl group-containing organic acid monoglyceride preferred for use in the production method of the invention is described in detail hereinunder.

The carboxyl group-containing organic acid monoglyceride usable in the invention maybe obtained by reacting a polyhydric organic acid anhydride and a fatty acid monoglyceride, generally according to the method described in JP-A 4-218597, Japanese Patent 3823524, etc.

The reaction maybe attained generally in the absence of a solvent, and for example, the reaction of succinic anhydride and a fatty acid monoglyceride having 18 carbon atoms may be completed at a temperature of around 120° C. for about 90 minutes. Thus obtained, the organic acid monoglyceride is generally in the form of a mixture containing organic acid, unreacted monoglyceride, diglyceride, and other oligomer. In the invention, the mixture of the type may be used directly as it is.

In case where the purity of the carboxyl group-containing organic acid monoglyceride is desired to be increased, the carboxyl group-containing organic acid monoglyceride in the mixture may be purified through distillation or the like. As a high-purity carboxyl group-containing organic acid monoglyceride, usable are commercial distilled monoglycerides. As commercial products of the carboxyl group-containing organic acid monoglyceride, for example, there are mentioned Riken Vitamin's Poem K-37V (glycerin citrate oleate ester), Kao's Step SS (glycerin stearate/palmate succinate ester), etc.

For the film of the invention, also usable is an organic acid satisfying the following requirements (1) to (3):

(1) The acid contains a structure in which a polyalcohol and a polycarboxylic acid bond together via an ester bond formed by them.

(2) The total of the molecules of the polyalcohol and the polycarboxylic acid forming the compound is at least 3.

(3) The compound has at least one unsaturated carboxyl group derived from a polycarboxylic acid.

In the organic acid satisfying the above-mentioned requirements (1) to (3), the unsubstituted carboxyl groups acts to enhance the peelability of film in solution-casting film formation plants (in peeling from a metal support on which dope has been cast); and in the invention, the organic acid satisfying the above-mentioned requirements (1) to (3) may be used as a peeling promoter.

Further, the unsubstituted carboxyl group adheres to the metal surface of support, and the polyalcohol moiety or the hydrophobic group moiety substituting for the polyalcohol moiety blocks the metal surface of support from an oxidizing agent such as oxygen or the like, and therefore, as compared with an organic acid not containing the polyalcohol moiety or the hydrophobic group moiety substituting for the polyalcohol moiety, the specific organic acid in the invention can prevent corrosion of metal more efficiently.

The organic acid satisfying the above-mentioned requirements (1) to (3) and usable as the peeling promoter for the film of the invention, and any other peeling promoter that may be combined with the specific organic acid are described below.

Not specifically defined, the polycarboxylic acid usable in the organic acid that satisfies the requirements (1) to (3) is, for example, preferably succinic acid, citric acid, tartaric acid, diacetyltartaric acid, malic acid, adipic acid.

In the carboxylic acid satisfying the requirements (1) to (3), the number of the molecules of the polycarboxylic acid is preferably from 1 to 20, more preferably from 1 to 15, even more preferably from 1 to 10.

As the polyalcohol for use in the organic acid satisfying the requirements (1) to (3), there are mentioned adonitol, arabitol, ethylene glycol, diethylene glycol, triethylene glycol, tetraethylene glycol, 1,2-propanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, glycerin, etc. Of those, preferred is glycerin.

In the carboxylic acid satisfying the requirements (1) to (3), the number of the molecules of the polyalcohol is preferably from 1 to 20, more preferably from 1 to 15, even more preferably from 1 to 10.

The organic acid satisfying the requirements (1) to (3) may have a structure in which, in addition to the polyalcohol and the polycarboxylic acid constituting the organic acid, a monoacid having a substituent having at least 4 carbon atoms forms an ester bond with the hydroxyl group of a part of the polyalcohol. Specific examples of the monoacid having a substituent having at least 4 carbon atoms are mentioned below.

The substituent in the monoacid having a substituent having at least 4 carbon atoms means R, when the monoacid having a substituent having at least 4 carbon atoms is represented by RCOOH.

### <<Fatty Acid>>

Caproic acid, heptylic acid, caprylic acid, pelargonic acid, lauric acid, myristic acid, palmitic acid, stearic acid, oleic acid, linolic acid, linolenic acid, ricinoleic acid, undecanoic acid.

### <<Alkylsulfuric Acid>>

Myristylsulfuric acid, cetylsulfuric acid, oleylsulfuric acid.

### <<Alkylbenzenesulfonic Acid>>

Dodecylbenzenesulfonic acid, pentadecylbenzenesulfonic acid.

### <<Alkylnaphthalenesulfonic Acid>>

Sesquibutylnaphthalenesulfonic acid, diisobutylnaphthalenesulfonic acid.

Of those, preferred are monoacids of fatty acids having a substituent having at least 4 carbon atoms; more preferred are caprylic acid, lauric acid, stearic acid and oleic acid; and even more preferred is oleic acid.

In the organic acid satisfying the requirements (1) to (3), preferably, the number of the molecules of the monoacid having a substituent having at least 4 carbon atoms is from 0 to 4, more preferably from 0 to 3, even more preferably from 0 to 2.

The organic acid satisfying the requirements (1) to (3) is preferably such that the total number of the molecules of the polyalcohol and the polycarboxylic acid to form the compound is at least 3, more preferably from 3 to 30, even more preferably from 3 to 20.

In the organic acid satisfying the requirements (1) to (3), the proportion of the monoacid having a substituent having at least 4 carbon atoms to the polycarboxylic acid and polyalcohol is not specifically defined, and two or more unsubstituted hydroxyl groups may remain in the organic acid.

The organic acid satisfying the requirements (1) to (3) has at least one, polycarboxylic acid-derived unsubstituted carboxylic group, and preferably has from 1 to 40, more preferably from 1 to 30 polycarboxylic acid-derived unsubstituted carboxylic groups.

One alone or two or more different types of the organic acid satisfying the requirements (1) to (3) may be used here either singly or as a mixture thereof. As the case may be, the organic acid satisfying the requirements (1) to (3) may be ionized, and may optionally form a salt with any arbitrary metal ion.

Preferred examples of the organic acid satisfying the requirements (1) to (3) for use in the invention are shown below.

Preferred are organic acids (partial condensates of organic acids) having the composition mentioned below.

TABLE 1

| | | | Monoacid Having |
|---|---|---|---|
| | | Polycarboxylic | Substituent with |
| | Polyalcohol | Acid | at least 4 carbon atoms |
| Organic Acid | glycerin | citric acid | oleic acid |
| Condensate A-1 | 2 to 3 | 1 to 2 | 0 to 1 |
| Condensate A-2 | 2 to 3 | 1 to 2 | 1 to 2 |
| Condensate A-3 | 2 to 4 | 2 to 3 | 0 to 1 |
| Condensate A-4 | 2 to 4 | 2 to 3 | 1 to 2 |
| Condensate A-5 | 5 to 6 | 3 to 4 | 1 to 2 |
| Condensate A-6 | 7 to 8 | 3 to 4 | 1 to 2 |

TABLE 2

| | | | Monoacid Having |
|---|---|---|---|
| | | Polycarboxylic | Substituent with |
| | Polyalcohol | Acid | at least 4 carbon atoms |
| Organic Acid | glycerin | citric acid | caprylic acid |
| Condensate B-1 | 2 to 3 | 1 to 2 | 0 to 1 |
| Condensate B-2 | 2 to 3 | 1 to 2 | 1 to 2 |
| Condensate B-3 | 2 to 4 | 2 to 3 | 0 to 1 |
| Condensate B-4 | 2 to 4 | 2 to 3 | 1 to 2 |
| Condensate B-5 | 5 to 6 | 3 to 4 | 1 to 2 |
| Condensate B-6 | 7 to 8 | 3 to 4 | 1 to 2 |

TABLE 3

| | | | Monoacid Having |
|---|---|---|---|
| | | Polycarboxylic | Substituent with |
| | Polyalcohol | Acid | at least 4 carbon atoms |
| Organic Acid | glycerin | citric acid | lauric acid |
| Condensate C-1 | 2 to 3 | 1 to 2 | 0 to 1 |
| Condensate C-2 | 2 to 3 | 1 to 2 | 1 to 2 |
| Condensate C-3 | 2 to 4 | 2 to 3 | 0 to 1 |
| Condensate C-4 | 2 to 4 | 2 to 3 | 1 to 2 |
| Condensate C-5 | 5 to 6 | 3 to 4 | 1 to 2 |
| Condensate C-6 | 7 to 8 | 3 to 4 | 1 to 2 |

TABLE 4

| | | | Monoacid Having |
|---|---|---|---|
| | | Polycarboxylic | Substituent with |
| | Polyalcohol | Acid | at least 4 carbon atoms |
| Organic Acid | glycerin | citric acid | stearic acid |
| Condensate D-1 | 2 to 3 | 1 to 2 | 0 to 1 |
| Condensate D-2 | 2 to 3 | 1 to 2 | 1 to 2 |
| Condensate D-3 | 2 to 4 | 2 to 3 | 0 to 1 |
| Condensate D-4 | 2 to 4 | 2 to 3 | 1 to 2 |
| Condensate D-5 | 5 to 6 | 3 to 4 | 1 to 2 |
| Condensate D-6 | 7 to 8 | 3 to 4 | 1 to 2 |

### (Content)

The amount of the organic acid of the general formula (1) to be contained in the film of the invention is in a ratio of from 0.01% by mass to less than 1% by mass of the cellulose acylate therein, preferably from 0.05% by mss to 0.5% by mass, more preferably from 0.1% by mass to 0.3% by mass.

When the amount of the organic acid of the general formula (1) relative to the cellulose acylate in the film is at least 0.01% by mass, then the acid attains the effect of improving the peelability in film formation.

On the other hand, though not adhering to any theory, when the content of the organic acid increases, then the film tends to whiten, and this may be considered because the compounds inside the film would aggregate together to promote phase separation in the film. In case where the amount of the organic acid of the general formula (1) relative to the cellulose acylate in the film is less than 1% by mass, then the organic acid concentration could be sufficiently low and therefore, when the film is thinned, the film can sufficiently exhibit the optical expressibility thereof, and in addition, the film can be prevented from whitening owing to the organic acid therein and the haze thereof can be therefore reduced.

The film of the invention can be formed in a mode of simultaneous or successive multilayer-casting on a support, and preferably, only the cellulose acylate solution to form the layer kept in contact with the support during casting contains the organic acid. In particular, in case where the cellulose acylate film of the invention is produced in an embodiment where only the cellulose acylate solution to form the layer kept in contact with the support during casting contains the organic acid, the organic acid may be localized in some degree on one side of the film.

In case where one face of the cellulose acylate film is called a face A and the other face thereof is a face B, preferably, the content of the organic acid existing in the depth of up to 2 μm from each surface of the face A and the face B, relative to the cellulose acylate in the film, satisfies the following formula (I):

0.85≦Xa/Xb≦1.0 (I)

Xa≦Xb (I′)

In the formula (I), Xa means the organic acid content in the depth of up to 2 μm from the surface of the face A; and Xb means the organic acid content in the depth of up to 2 μm from the surface of the face B.

Preferably, the range of Xa/Xb is from 0.85 to 1.0, more preferably from 0.9 to 1.0. In the finally-completed film, where the organic acid is localized on a level exceeding the above range, the miscibility of the organic acid on the side where the amount of the acid is large may worsen and the film may whiten.

### (Other Peeling Promoter)

In addition to the organic acid represented by the general formula (1), any known peeling promoter may be added to the film of the invention. As the known peeling promoter, for example, preferred are the compounds described in JP-A 2006-45497, paragraphs 0048 to 0069.

### <Other Additive>

Various additive than the peeling promoter mentioned above may be added to the film of the invention, for example, a polycondensate polymer, a retardation regulator (retardation enhance, retardation reducer), plasticizer such as phthalate, phosphate, etc., UV absorbent, antioxidant, mat agent, etc.

### (Polycondensate Polymer)

The film of the invention may contain a polycondensate polymer from the viewpoint of reducing the haze thereof.

As the polycondensate polymer, widely employable here are polymer additives known as additives to cellulose acylate film. The additive content is preferably from 1 to 35% by mass of the cellulose resin, more preferably from 4 to 30% by mass, even more preferably from 5 to 20% by mass.

The polymer additive usable as the polycondensate polymer in the film of the invention has a recurring unit in the compound, and preferably has a number-average molecular weight of from 500 to 10000. The polymer additive may have the function of increasing the evaporation speed of solvent and may have a function of reducing the residual solvent amount in solution-casting method film formation. Further, the polymer additive could exhibit other useful effects from the viewpoint of enhancing the mechanical properties of the film, imparting softness to the film, imparting water absorption resistance to the film and reducing the water permeability of the film. In addition, the polycondensate polymer could exhibit useful effects from the viewpoint of promoting the miscibility of the organic acid with cellulose acylate to thereby prevent the film from whitening.

Here the number-average molecular weight of the polycondensate polymer of the polymer additive for use in the invention is preferably from 500 to 8000, more preferably from 500 to 5000, even more preferably from 500 to 2000.

The polycondensate polymer of the polymer additive usable in the invention is described below with reference to specific examples thereof given below. Needless-to-say, the polycondensate polymer of the polymer additive usable in the invention is not limited to these examples.

Preferably, the polycondensation-type polymer is a non-phosphate-type ester compound. The “non-phosphate-type ester compound” means an ester compound not including phosphates.

The polymer additive of the polycondensation-type polymer includes polyester polymers (aliphatic polyester polymers, aromatic polyester polymers, etc.), and copolymers of a polyester ingredient and any other ingredient. Preferred are aliphatic polyester polymers, aromatic polyester polymers, copolymers of a polyester polymer (aliphatic polyester polymer, aromatic polyester polymer, etc.) and an acrylic polymer, and copolymers of a polyester polymer (aliphatic polyester polymer, aromatic polyester polymer, etc.) and a styrenic polymer; and more preferred are polyester compounds having an aromatic ring moiety as at least one copolymerization ingredient.

The aliphatic polyester-type polymers is one produced by reaction of a mixture of an aliphatic dicarboxylic acid having from 2 to 20 carbon atoms, and a diol selected from the group consisting of aliphatic diols having from 2 to 12 carbon atoms and alkyl ether diols having from 4 to 20 carbon atoms. Both ends of the reaction product may be as such, or may be blocked by further reaction with monocarboxylic acids, monoalcohols or phenols. The terminal blocking maybe effected for the reason that the absence of a free carboxylic acid in the plasticizer is effective for the storability of the plasticizer. The dicarboxylic acid for the polyester plasticizer for use in the invention is preferably an aliphatic dicarboxylic having from 4 to 20 carbon atoms, or an aromatic dicarboxylic acid having from 8 to 20 carbon atoms.

### (Retardation Reducer)

As the retardation reducer in the invention, widely employable are phosphate compounds and compounds except non-phosphate compounds known as additives to cellulose acylate film.

The polymer-type retardation reducer usable herein is selected from phosphate-type polyester polymers, styrenic polymers, acrylic polymers and their copolymers; and preferred are acrylic polymers and styrenic polymers. Preferably, the film in the invention contains at least one polymer having an inherent negative birefringence, such as styrenic polymers and acrylic polymers.

The low-molecular retardation reducer that is a compound except non-phosphate compounds includes the following. These may be solid or oily. Briefly, the melting point and the boiling point of the compounds are not specifically defined. For example, there may be mentioned a mixture of UV absorbent materials in which the melting or boiling point of one material is not higher than 20° C. and that of the other is higher than 20° C., and a mixture of degradation inhibitors of the same type as above. IR absorbent dyes usable herein are described, for example, in JP-A 2001-194522. The time when the additive is added may be at anytime in the cellulose acylate solution (dope) production step. As the case may be, a step of adding the additive maybe additionally provided in the final stage after the dope preparation step. The amount of the material to be added is not specifically defined so far as the material can express its function.

The low-molecular retardation reducer that is a compound except non-phosphate compounds is not specifically defined, and its details are described in JP-A 2007-272177, [0066] to [0085].

The compounds represented by the formula (1) in JP-A2007-272177, [0066] to [0085] can be produced according to the following method.

The compound of the formula (1) in the patent publication can be produced through condensation of a sulfonyl chloride derivative and an amine derivative.

The compound represented by the genera formula (2) in JP-A 2007-272177 can be produced through dehydrating condensation of a carboxylic acid and an amine using a condensing agent (for example, dicyclohexylcarbodiimide (DCC), etc.), or through substitution reaction of a carboxylic acid chloride derivative and an amine derivative.

The retardation reducer is preferably an Rth reducer from the viewpoint of realizing a favorable Nz factor. The Rth reducer of the retardation reducer includes acrylic polymers and styrenic polymers as well as low-molecular compounds of the formulae (3) to (7) of JP-A 2007-272177. Of those, preferred are acrylic polymers and styrenic polymers, and more preferred are acrylic polymers.

Preferably, the retardation reducer is added in a ratio of from 0.01 to 30% by mass relative to the cellulose resin, more preferably from 0.1 to 20% by mass, even more preferably from 0.1 to 10% by mass.

When the amount is at most 30% by mass, the compatibility of the compound with the cellulose resin can be bettered, and the formed film can be prevented from whitening. In case where two or more different types of retardation reducers are used, preferably, their total amount is within the above range.

### (Retardation Enhancer)

The cellulose acylate film of the invention may contain a retardation enhancer for the purpose of expressing the retardation value thereof. The retardation enhancer is not specifically defined. There may be mentioned rod-shaped or discotic compounds, as well as those of the above-mentioned non-phosphate compounds that have a retardation enhancing capability. As the rod-shaped or discotic compounds, compounds having at least two aromatic rings are preferably used herein as the retardation enhancer.

The amount to be added of the retardation enhancer of a rod-shaped compound is preferably from 0.1 to 30 parts by mass relative to 100 parts by mass of the polymer ingredient containing cellulose acylate, more preferably from 0.5 to 20 parts by mass. Preferably, the amount of the discotic compound contained in the retardation enhancer is less than 3 parts by mass relative to 100 parts by mass of the cellulose acylate, more preferably less than 2 parts by mass, even more preferably less than 1 part by mass.

Discotic compounds are superior to rod-shaped compounds in point of the Rth retardation enhancing capability thereof, and therefore the former is favorably used when an especially large Rth retardation is needed. Two or more different types of retardation enhancers may be used here as combined.

Preferably, the retardation enhancer for use herein has a maximum absorption in a wavelength region of from 250 to 400 nm, but doe not have any substantial absorption in the visible region.

The details of the retardation enhancer are described in Disclosure Bulletin 2001-1745, p. 49.

### (Plasticizer)

The film of the invention may contain a plasticizer. As the plasticizer, usable are phosphates or carboxylates.

Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetylcitrate (OACTE) and tributyl O-acetylcitrate (OACTB). Examples of other carboxylates include butyl oleate, methylacetyl ricinoleate, dibutyl sebacate, and various trimellitates. Preferred for use herein are phthalate plasticizers (DMP, DEP, DBP, DOP, DPP, DEHP). More preferred are DEP and DPP.

### (Sugar Ester)

Preferably, the film of the invention may contain an ester compound having 1 to 12 structures of at least one of pyranose and furanose with all or a part of OH groups being esterified.

The degree of esterification in the ester compound having 1 to 12 structures of at least one of pyranose and furanose with all or a part of OH being esterified is preferably at least 70% of the total number of OH groups in the pyranose or furanose before the esterification.

In the invention, the above ester compounds are generally referred to as sugar esters or sugar ester compounds.

Ester compounds which can be used in the invention are exemplified below. The ester compounds which can be used in the invention are not limited to the following examples: glucose, galactose, mannose, fructose, xylose, arabinose, lactose, sucrose, nystose, 1F-furactosylnystose, stachyose, maltitol, lactitol, lactulose, cellobiose, maltose, cellotriose, maltotriose, raffinose and kestose. Gentiobiose, gentiotriose, gentiotetraose, xylotriose and galactosylsucrose are also exemplified. Among them, preferred are compounds having both pyranose and furanose. For example, preferred are scrose, kestose, nystose, 1F-furactosylnystose and stachyose, and more preferred is scrose.

A monocarboxylic acid used for esterfication of all or a part of OH groups in pyranose or furanose is not specifically limited. Known aliphatic monocarboxylic acids, alicyclic monocarboxylic acids and armatic monocarboxylic acids may be used. These carboxylic acids can be used singly or in combination.

Preferred aliphatic monocarboxylic acids for use herein are saturated fatty acids such as acetic acid, propionic acid, butyric acid, isobutyric acid, valeric acid, caproic acid, enanthic acid, caprylic acid, pelargonic acid, caprylic acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotinic acid, heptacosanoic acid, montanic acid, melissic acid, lacceric acid, etc.; and unsaturated fatty acids such as undecylic acid, oleic acid, sorbic acid, linolic acid, linolenic acid, arachidonic acid, etc.

Preferred examples of the alicyclic monocarboxylic acid are cyclopentanecarboxylic acid, cyclohexanecarboxylic acid, cyclooctanecarboxylic acid, and their derivatives.

Preferred examples of the aromatic monocarboxylic acid are benzoic acid, those prepared by introducing an alkyl group or an alkoxy group into the benzene ring of benzoic acid such as, toluic acid, etc., aromatic monocarboxylic acids having at least 2 benzene rings such as succinic acid, benzylic acid, biphenylcarboxylic acid, naphthalenecarboxylic acid, tetralincarboxylic acid, etc., and their derivatives. More concretely, preferred are xylic acid, hemellitic acid, mesitylenic acid, prehnitylic acid, γ-isodurylic acid, durylic acid, mesitoic acid, α-isodurylic acid, cuminic acid, α-toluic acid, hydratropic acid, atropic acid, hydrosuccinic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid and p-coumaric acid. Particularly preferred are benzoic acid and naphtylic acid.

An ester compound of an oligosaccharide can be used as the compound having 1 to 12 structures of at least one of pyranose and furanose.

Oligosaccharide is produced by treating starch, sucrose or others with an enzyme such as amylase. Examples of oligosacchrides used in the invention include maltooligosaccharide, isomaltooligosaccharide, furacto oligosaccharide, galactooligosaccharide and xylooligosaccharide.

The above ester compounds are a compound having 1 to 12 structures of at least one of pyranose or furanose represented by the following general formula (A) in which R¹¹ to R₁₅ and R²¹ to R²⁵ represent an acyl group having from 2 to 22 carbon atoms or a hydrogen atom, m and n each represents an integer of from 0 to 12, and m +n is an integer of from 0 to 12.

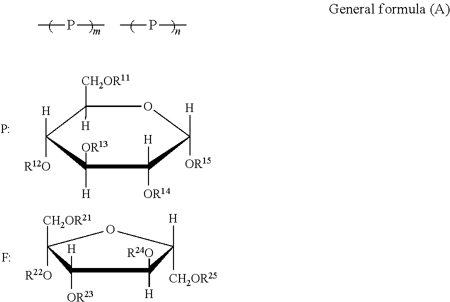

R¹¹ to R₁₅ and R²¹ to R²⁵ are preferably an baneozyl group or a hydrogen atom. The benzoyl group may have a substituent R²⁶ such as an alkyl group, an alkenyl group, an alkoxyl group and a phenyl group which may be further substituted. Oligosaccharides can be produced by the same method as the ester compounds used in the invention.

Followings are examples of ester compounds which can be used in the invention but the scope of the invention is not limited thereto:

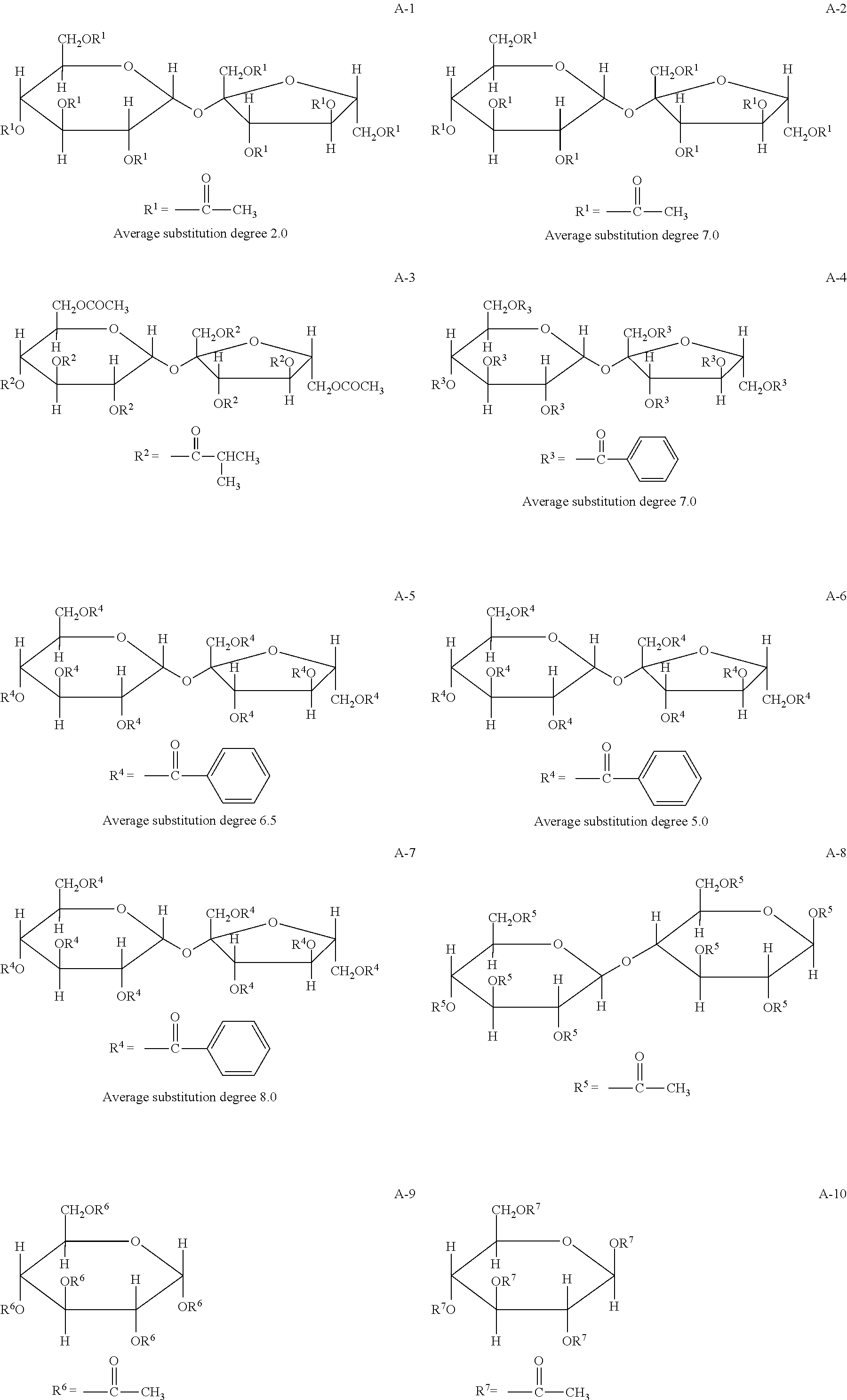

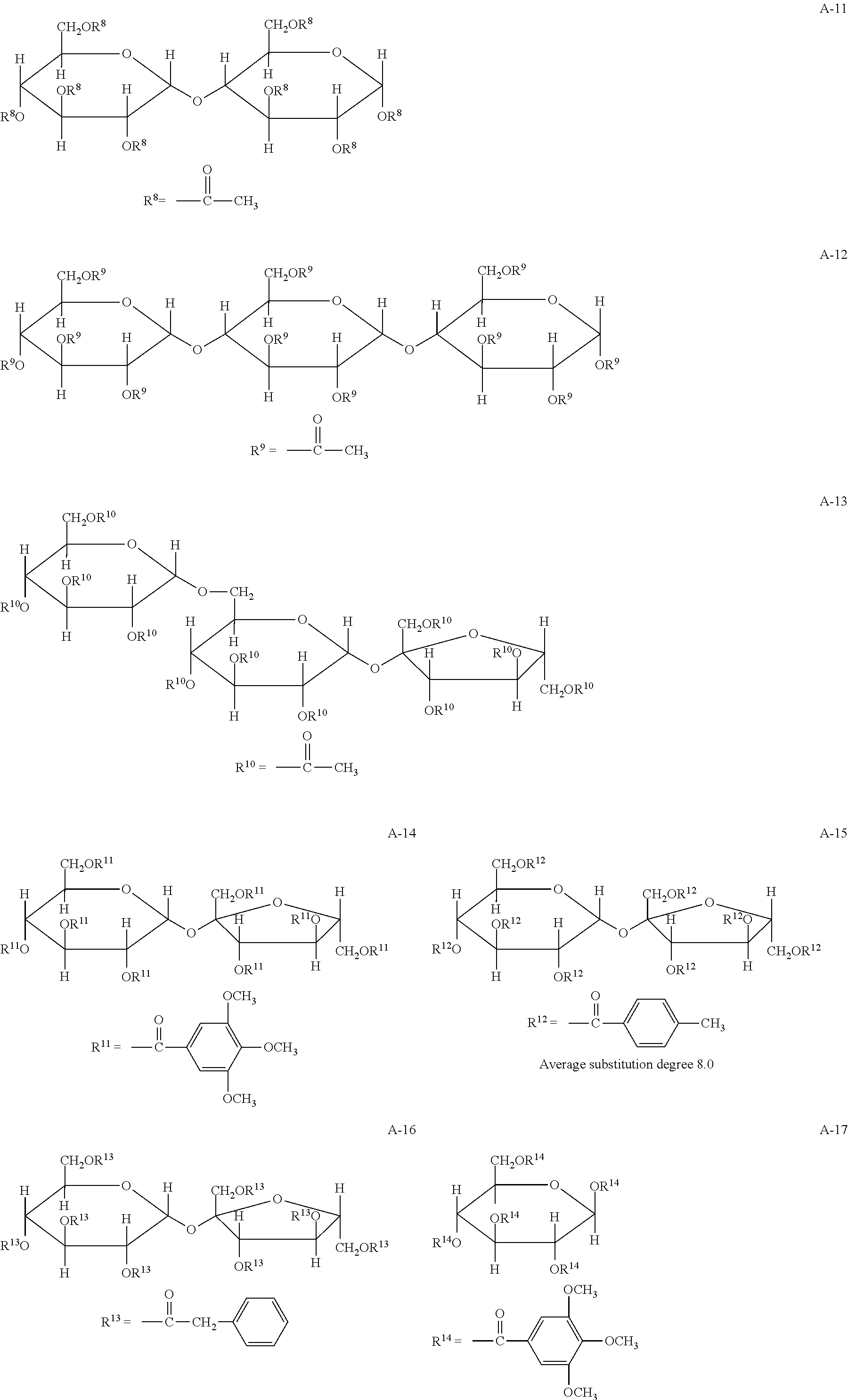

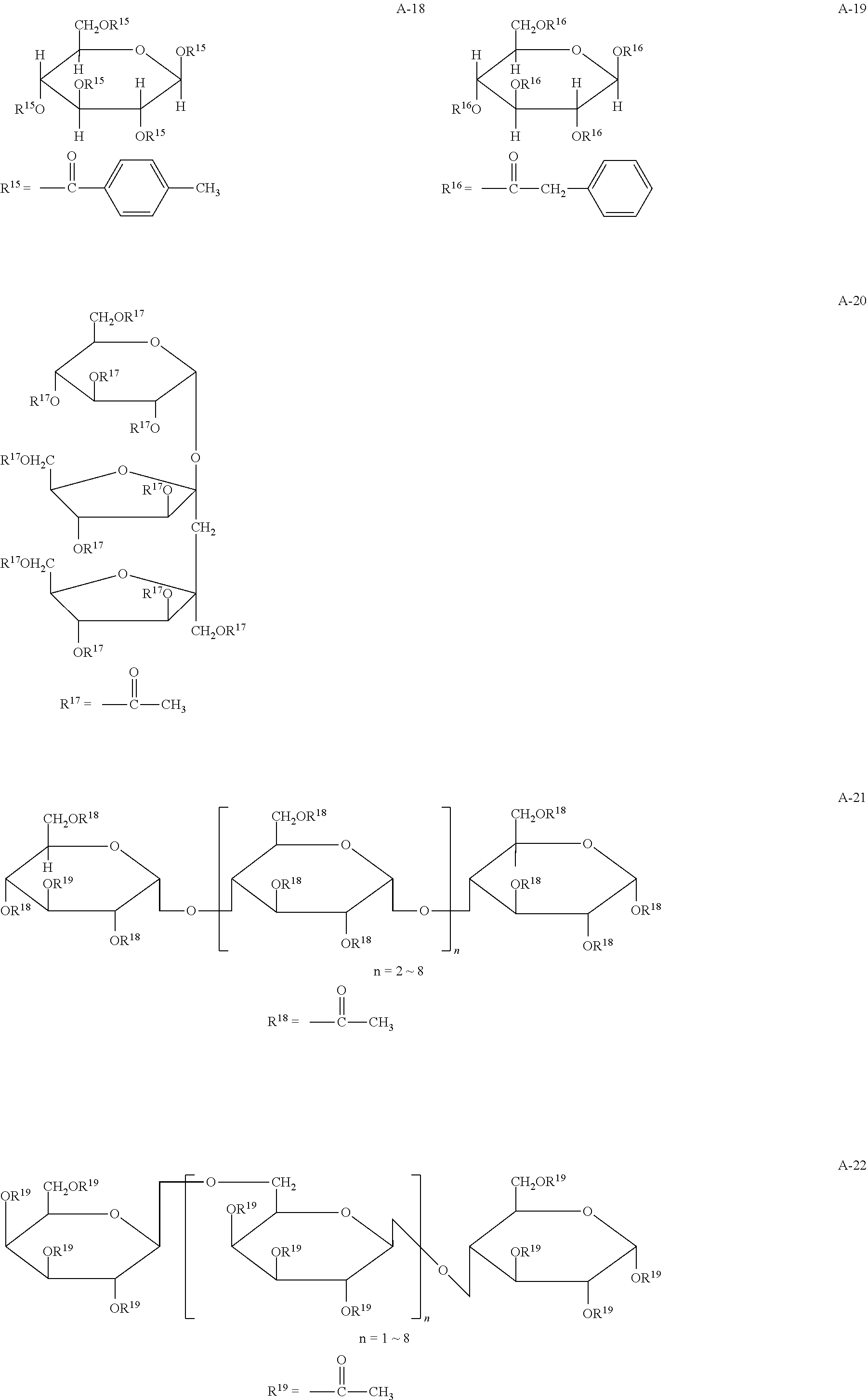

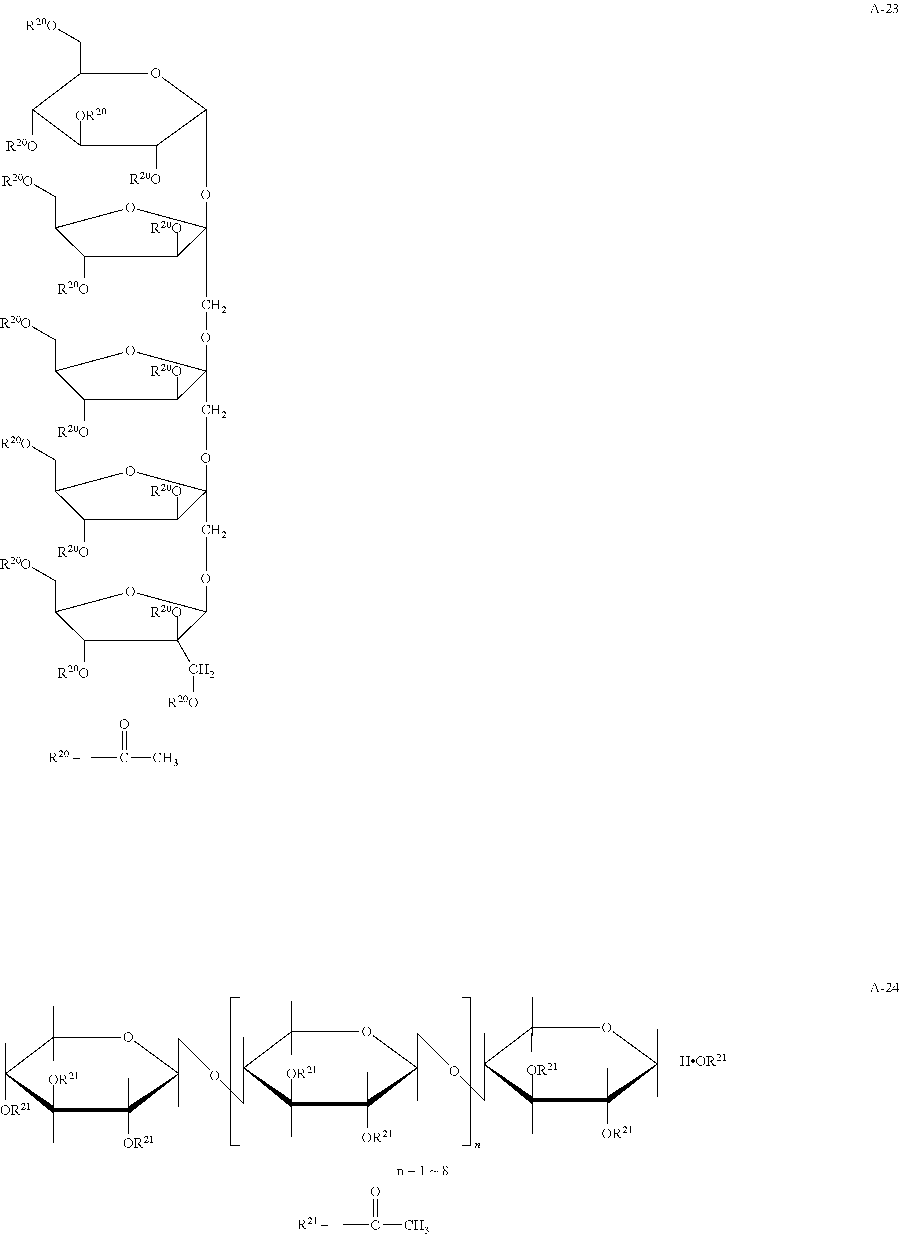

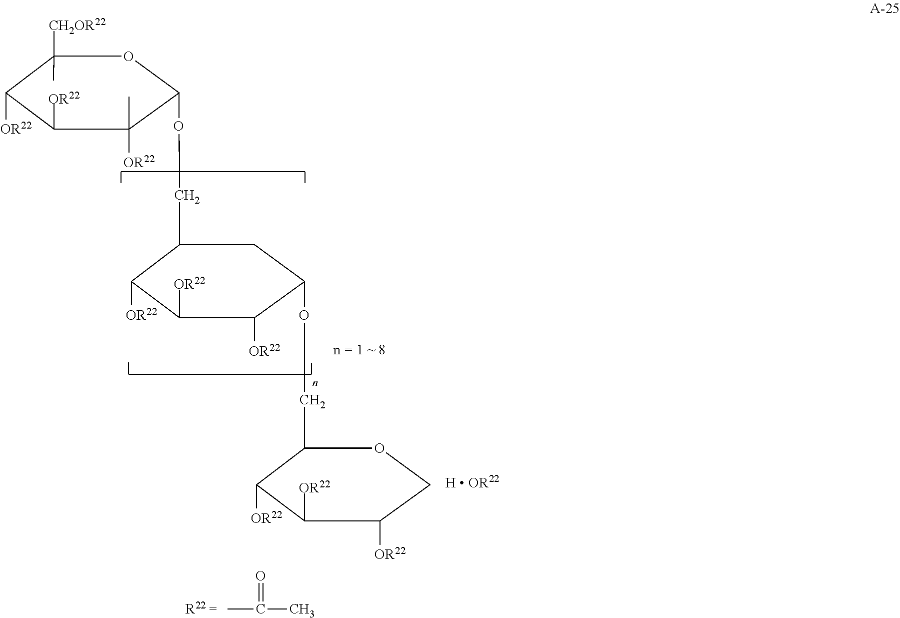

The cellulose acylate film of the invention preferably contains the sugar ester compound described above in an amount of from 0.5 to 30% by weight, more preferably from 2 to 15% by weight of the cellulose ester film.

### (Antioxidant)

The film of the invention may contain a known antioxidant, for example, a phenolic or hydroquinone-type antioxidant such as 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone, pentaerythrityl tetrakis [3-(3,5-di-tert-butyl-4-hydroxyphenyl)propionate] or the like may be added to the cellulose acylate solution. Preferred is use of a phosphate-type antioxidant such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite, bis(2,4-di-tert-butylphenyl)pentaerythritol diphosphite, etc. Preferably, the amount of the antioxidant to be added is from 0.05 to 5.0 parts by mass relative to 100 parts by mass of the cellulose resin.

### (UV Absorbent)

The film of the invention may contain a UV absorbent from the viewpoint of preventing the degradation of polarizer, liquid crystal, etc. As the UV absorbent, preferred are those excellent in UV absorbability at a wavelength of 370 nm or less and poorly absorbing visible light having a wavelength of 400 nm or more, from the viewpoint of securing good liquid crystal display performance. Specific examples of the UV absorbent preferred for use in the invention include, for example, hindered phenolic compounds, hydroxybenzophenone compounds, benzotriazole compounds, salicylate compounds, benzophenone compounds, cyanoacrylate compounds, nickel complex compounds, etc. Examples of the hindered phenolic compounds include 2,6-di-tert-butyl-p-cresol, pentaerythrityl tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris- (3, 5-di-tert-butyl-4-hydroxybenzyl)isocyanurate, etc. Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, (2-(2′-hydroxy-3′,5′-di-tert-amylphenyl)-5-chlorobenzotriazole, 2,6-di-tert-butyl-p-cresol, pentaerythrityl tetrakis[3-(3,5-di-tert-butyl-4-hydroxyphenyl)propionate], etc. The amount of the UV inhibitor is preferably from 1 ppm to 1.0% by mass in the entire optical film, more preferably from 10 to 1000 ppm.

### (Matting Agent)

A matting agent may be added to the cellulose acylate film from the viewpoint of securing film slidability and securing safe production. The matting agent may be an inorganic compound matting agent or an organic compound matting agent.

Preferred examples of the matting agent of an inorganic compound include silicon-containing inorganic compounds (e.g., silicon dioxide, calcined calcium silicate, hydrated calcium silicate, aluminium silicate, magnesium silicate, etc.), titanium oxide, zinc oxide, aluminium oxide, barium oxide, zirconium oxide, strontium oxide, antimony oxide, tin oxide, tin-antimony oxide, calcium carbonate, talc, clay, calcined kaolin, calcium phosphate, etc. More preferred are silicon-containing inorganic compounds and zirconium oxide. Particularly preferred is silicon dioxide since it can reduce the haze of cellulose acylate films. As fine particles of silicon dioxide, marketed productions can be used, including, for example, AEROSIL R972, R972V, R974, R812, 200, 200V, 300, R202, OX50 and TT600 (all of them are manufactured by NIPPON AEROSIL CO., LTD.) etc. As fine particles of zirconium oxide, for example, those available in the market under trade names of AEROSIL R976 and R811 (manufactured by NIPPON AEROSIL CO., LTD.) can be used.

Preferred examples of the matting agent of an organic compound include polymers such as silicone resins, fluororesins, acrylic resins, etc. Above all, more preferred are silicone resins. Of silicone resins, even more preferred are those having a three-dimensional network structure. For example, usable are commercial products of Tospearl 103, Tospearl 105, Tospearl 18, Tospearl 120, Tospearl 145, Tospearl 3120 and Tospearl 240 (all trade names by Toshiba Silicone), etc.

When the matting agent is added to a cellulose acylate solution, any method is employable with no problem, as long as it can produce a desired cellulose acylate solution. For example, the additive may be added in the stage where a cellulose acylate is mixed with a solvent; or the additive may be added to a mixture solution prepared from a cellulose acylate and a solvent. Further, the additive may be added to and mixed with a dope just before the dope is cast, and this is a so-called direct addition method, in which the ingredients may be on-line mixed by screw kneading. Concretely, preferred is a static mixer such as an in-line mixer. As the in-line mixer, for example, preferred is a static mixer, SWJ (Toray's static tubular mixer, Hi-Mixer, by Toray Engineering). Regarding the mode of in-line addition, JP-A 2003-053752 describes an invention of a method for producing a cellulose acylate film wherein, for the purpose of preventing concentration unevenness and particle aggregation, the distance L between the nozzle tip through which an additive liquid having a composition differing from that of the main material dope and the start end of an in-line mixer is controlled to be at most 5 times the inner diameter d of the main material feeding line, thereby preventing concentration unevenness and aggregation of matting particles, etc. The patent reference discloses a more preferred embodiment, in which the distance (L) between the nozzle tip opening through which an additive liquid having a composition differing from that of the main material dope and the start end of the in-line mixer is controlled to be at most 10 times the inner diameter (d) of the feeding nozzle tip opening, and the in-line mixer is a static non-stirring tubular mixer or a dynamic stirring tubular mixer. More concretely, the patent reference discloses that the flow ratio of the cellulose acylate film main material dope/in-line additive liquid is from 10/1 to 500/1, more preferably from 50/1 to 200/1. JP-A 2003-014933 discloses an invention of providing a retardation film which is free from a trouble of additive bleeding and a trouble of interlayer peeling and which has good lubricity and excellent transparency; and regarding the method of adding additives to the film, the patent reference says that the additive may be added to a dissolving tank, or the additive or a solution or dispersion of the additive may be added to the dope being fed in the process from the dissolving tank to a co-casting die, further describing that in the latter case, mixing means such as a static mixer is preferably provided for the purpose of enhancing the mixing efficiency therein.

### <Film Layer Configuration>

The film of the invention may be a single-layer film or a laminate of two or more layers, but is preferably a multilayer laminate film in which the constitutive layers may have different functions. In the production method for the cellulose acylate film of the invention, cellulose acylate solutions may be simultaneously or successively multilayer-cast on a support for film formation thereon, as described below; and in such an embodiment, the layers could mix with each other so that any definite interface could not be formed between the layers.

In case where the film of the invention is a laminate of two or more layers, more preferably, the film is a two-layer film or a three-layer film. In the laminate of two or more layers, the film surface layer is called a surface layer; and in the laminate of three or more layers, the layer inside the film is called an inner layer. Preferably, the film of the invention comprises a surface layer on the side thereof to face the support in film production according to a solution-casting method (hereinafter this may be referred to as a support-side layer or a skin B layer) and one core layer thicker than the support-side layer. In case where the film of the invention is a two-layer laminate film, preferably, the surface layer thereof not the support-side layer is the core layer.

In case where the film of the invention is a two-layer or more multilayer laminate film, the cellulose acylate in each layer may be one having the same degree of acyl substitution or may be one having a different degree of acyl substitution. Above all, in the film of the type, it is desirable that the cellulose acylate of each layer has the same degree of acyl substitution from the viewpoint of the optical expressibility of the film, the adhesiveness between the constitutive layers and the production cost thereof.

In case where film of the invention is a multilayer laminate film, one type alone of cellulose acylate may be in each constitutive layer or multiple types of cellulose acylates may be in one layer as combined; however, it is desirable that the cellulose acylate in each layer in the film of the invention all has the same degree of acyl substitution from the viewpoint of controlling the optical properties of the film.

### (Retardation)

In this description, Re(λ) and Rth(λ) each mean the in-plane retardation and the thickness-direction retardation, respectively, of the film at a wavelength of λ. Unless otherwise specifically indicated in this description, the wavelength λ is 590 nm. Re(λ) is measured by applying a light having a wavelength of λ nm to a film sample in the normal direction of the film, using KOBRA 21ADH or WR (by Oji Scientific Instruments). In selecting the wavelength for measurement, λ nm, the wavelength selection filter is exchanged by hand operation or the found data are converted by a program or the like to thereby determine the measurement wavelength.

In case where the film to be analyzed can be expressed as a monoaxial or biaxial index ellipsoid, Rth(λ) thereof is computed according to the method mentioned below.

Based on Re(λ) mentioned above, Rth(λ) is determined as follows: With the in-plane slow axis (determined by KOBRA 21ADH or WR) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10°, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above, in the case of a film having a direction in which the retardation value thereof is zero at a certain tilt angle relative to the in-plane slow axis, as the rotation axis, in the normal direction, the sign of the retardation value at a tilt angle larger than that tilt angle is changed to negative, and then the data are computed with KOBRA 21ADH or WR.

Apart from this, Rth may also be measured as follows: With the slow axis taken as the tilt axis (rotation axis) of the film (in case where the film has no slow axis, the rotation axis of the film may be in any in-plane direction of the film), the retardation is measured in any desired two directions, and based on the thus-determined retardation data, the assumptive mean refractive index and the inputted film thickness, Rth is computed according to the following formulae (3) and (4).

(3)

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}}$$

In this, Re(θ) means the retardation of the film in the direction tilted by an angle θ from the normal direction to the film. In the formula (3), nx means the refractive index in the in-plane slow axis direction; ny means the refractive index in the direction perpendicular to nx in the plane; and nz means the refractive index in the direction perpendicular to nx and ny. d means the film thickness.

Rth={(nx+ny)/2−nz}×d (4)

In case where the film to be analyzed could not be expressed as a monoaxial or biaxial index ellipsoid, or that is, in case where the film does not have an optic axis, Rth(λ) thereof is computed according to the method mentioned below.

Based on Re(λ) mentioned above, Rth(λ) is determined as follows: With the in-plane slow axis (determined by KOBRA 21ADH or WR) taken as the tilt axis (rotation axis) of the film, Re (λ) of the film is measured at 11 points in all thereof in the direction tilted by from −50 degrees to +50 degrees relative to the film normal direction at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above measurement, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59). With the assumptive mean refractive index and the film thickness inputted thereinto, KOBRA 21ADH or WR can compute nx, ny and nz. From the thus-computed data nx, ny and nz, Nz=(nx−nz)/(nx31 ny) is induced.

The cellulose acylate film of the invention is favorably used as a protective film for polarizer, and in particular, favorably used also as a retardation film for various liquid crystal modes. The retardation film of the invention comprises the cellulose acylate film of the invention.

In case where the cellulose acylate film of the invention is used as a retardation film, the film preferably satisfies the following formula (1) and formula (2):

30 nm≦Re(590)≦100 nm (1)

80 nm≦Rth(590)≦280 nm (2)

In the formulae (1) and (2), Re(590) and Rth(590) each mean the in-plane retardation value and the thickness-direction retardation value, respectively, of the film measured with a light having a wavelength of 590 nm in an environment at 25° C. and at a relative humidity of 60%.

More preferably, the film satisfies the following formulae (1′) and (2′) :

40 nm≦Re(590)≦100 nm (1′)

100 nm≦Rth(590)≦250 nm (2′)

When Re(590) and Rth(590) of the film satisfy the above-mentioned formulae (1) and (2), the film is more preferably used as a retardation film.

More preferred optical characteristics of the cellulose acylate film vary depending on the liquid crystal mode to which the film is applied.

For VA-mode use, Re(590) of the film is more preferably from 30 to 200 nm, even more preferably from 30 to 150 nm, still more preferably from 40 to 100 nm; and Rth(590) thereof is more preferably from 70 to 400 nm, even more preferably from 100 to 300 nm, still more preferably from 100 to 250 nm.

For TN-mode use, Re(590) of the film is more preferably from 0 to 100 nm, even more preferably from 20 to 90 nm, still more preferably from 50 to 80 nm; and Rth(590) thereof is more preferably from 20 to 200 nm, even more preferably from 30 to 150 nm, still more preferably from 40 to 120 nm.

For TN-mode use, an optical anisotropic layer may be formed on the cellulose acylate film having the above-mentioned retardation value, thereby producing an optical compensatory film.

The cellulose acylate film of the invention is characterized by the high optical expressibility thereof. Concretely, the value of |Re(590)| per the thickness of the film is preferably larger, and more preferably satisfies the following formula (5):

2.5×10⁻³≦|Rth(590)|/d (5)

In the formula (5), Rth(590) means the thickness-direction retardation value of the film measured with a light having a wavelength of 590 nm in an environment at 25° C. and at a relative humidity of 60%; and d means the thickness of the film.

Especially preferably, the value of Rth (unit: nm)/d (μm) of the cellulose acylate film of the invention is at least 2.6×10⁻³.

### (Haze)

Preferably, the film of the invention has a total haze of at most 1% and an internal haze of at most 0.1%.

More preferably, the total haze of the cellulose acylate film of the invention is at most 0.5%, even more preferably at most 0.3%, still more preferably at most 0.2%. As an optical film, the film transparency is important. The haze may be measured with a haze meter “HGM-2DP” (by Suga Test Instruments) according to JIS K-6714.

On the other hand, the internal haze of the cellulose acylate film of the invention is preferably at most 0.1%, more preferably at most 0.07%, even more preferably at most 0.05%. In the invention, the internal haze was measured according to the method mentioned below.

A few drops of liquid paraffin were added to the surface and the back of the film, then the film was sandwiched between two glass sheets each having a thickness of 1 mm (Microslide Glass Lot No. 59111, by MATSUNAMI) in such a manner that the film could be completely optically sealed up between the two glass sheets to thereby remove the surface haze, and in that condition, the haze of the sample was measured. Separately, liquid paraffin alone was sandwiched between the two glass sheets and its haze was measured. The latter value was detracted from the former value to give the internal haze (HI) of the film.

### (Film Thickness)

Preferably, the thickness of the film of the invention is at most 60 μm, more preferably from 20 to 60 μm, even more preferably from 30 to 55 μm for keeping the optical characteristics of the film and improving processability in film formation and polarizer fabrication.

In case where the film of the invention has a laminate structure of two or more layers, preferably, the thickness of the core layer is at most 58 μm, more preferably from 28 to 68 μm, even more preferably from 18 to 58 μm. Also preferably, the thickness of the surface layer (skin B layer) of the film on the side kept in contact with the support in casting for film formation is at most 5 μm, more preferably from 1 to 4 μm, even more preferably from 1 to 3 μm. In case where the film of the invention has a laminate structure of 3 or more layers and where the film has a surface layer (skin A layer) on the air side opposite to the side kept in contact with the support in casting for film formation, the preferred thickness of the surface layer is the same as the above-mentioned preferred range of the skin B layer.

### (Film Width)

Preferably, the width of the film of the invention is from 700 to 3000 mm, more preferably from 1000 to 2800 mm, even more preferably from 1500 to 2500 mm.

### [Method for Producing Cellulose Acylate Film]

The method for producing the cellulose acylate film of the invention (hereinafter this may be referred to as the production method of the invention) includes the following first embodiment and second embodiment.

The first embodiment of the production method of the invention comprises (1) a step of preparing a solution for core layer containing a cellulose acylate (in which the content of the organic acid represented by the following general formula (1) is at most 3% by mass of the cellulose acylate) and a solution for support-side layer containing a cellulose acylate and an organic acid represented by the following general formula (1) in an amount of from 0.1% by mass to 20% by mass of the cellulose acylate, (2) a step of simultaneously or successively multilayer-casting the core layer solution and the support-side layer solution prepared in the previous step (1), onto a support, (3) a step of drying the solution multilayer-cast in the previous step (2) on the support and then peeling it from the support, and (4) a step of stretching the film as peeled in the previous step (3), wherein at least 90% by mass of the cellulose acylate contained in the core layer solution and the support-side layer solution has a total degree of acyl substitution of from 1.5 to 2.7, and the core layer solution and the support-side layer solution are so controlled that the casting thickness of the support-side layer solution is at least 0.5% of the total casting thickness of the core layer solution and the support-side layer solution.

The second embodiment of the production method of the invention comprises (A) a step of preparing a solution containing a cellulose acylate, (B) a step of preparing a solution of an organic acid represented by the following general formula (1), (C) a step of applying the organic acid solution prepared in the previous step (B) onto a support in such a manner that the amount of the organic acid could be from 0.001 mg/cm² to 0.8 mg/cm², (D) a step of casting the solution prepared in the previous step (A) onto the layer formed by applying the organic acid solution to the support in the previous step (C), (E) a step of drying the cellulose acylate solution cast in the previous step (D), on the support and peeling it from the support, and (F) a step of stretching the film peeled in the previous step (E), wherein at least 90% by mass of the cellulose acylate has a total degree of acyl substitution of from 1.5 to 2.7.

X-L-(R¹)ₙ (1)

In the general formula (1), X represents an acid group having an acid dissociation constant of at most 5.5; L represents a single bond or a lining group having two or more valence; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms, or a heterocyclic group having from 6 to 30 carbon atoms, which may be further substituted; n is 1 when L is a single bond but is (the valence of L-1) when L is a lining group having two or more valence.

The production method of the invention is described in detail hereinunder. Preferably, the cellulose acylate film is produced according to a solvent casting method. For production examples of cellulose acylate film according to a solvent casting method, referred to are U.S. Pat. Nos. 2,336,310, 2,367,603, 2,492,078, 2,492,977, 2,492,978, 2,607,704, 2,739,069, 2,739,070; British Patent 640731, 736892; JP-B 45-4554, 49-5614; JP-A 60-176834, 60-203430, 62-115035, etc. The cellulose acylate film may be stretched. For the method of stretching treatment and the condition thereof, referred to are, for example, JP-A 62-115035, 4-152125, 4-284211, 4-298310, 11-48271, etc.

### <Casting Method>

The solution casting method includes a method of extruding the prepared dope uniformly onto a metal support through a pressure die; a method in which the dope once cast onto a metal support is leveled with a blade to control the thickness of the formed film; a method of using a reverse roll coater in which the film thickness is controlled by the reversely-rotating roll, etc. Preferred is the method of using a pressure die. The pressure die includes a coat-hanger type die, a T-die, etc., any of which is favorably usable here. Apart from the methods described herein, any other various types of known methods for producing films by casting cellulose triacetate solution are employable here. In consideration of the difference in the boiling point of the solvents used, the casting condition maybe settled, and the same effects as those described in the related patent publications can also be obtained here.

The support for use in producing the film of the invention is preferably an endlessly running metal support. As the endlessly running metal support, usable is a drum of which the surface is mirror-finished by chromium plating, or a stainless belt (band) of which the surface is mirror-finished by polishing. One or more pressure dies maybe arranged above the metal support. Preferably, one or two pressure dies are arranged. In case where two or more pressure dies are arranged, the dope to be cast may be divided into portions suitable for the individual dies; or the dope maybe fed to the die at a suitable proportion via a plurality of precision metering gear pumps. The temperature of the dope (resin solution) to be cast is preferably from −10 to 55° C., more preferably from 25 to 50° C. In this case, the solution temperature may be the same throughout the entire process, or may differ in different sites of the process. In case where the temperature differs in different sites, the dope shall have the desired temperature just before cast.

The material of the metal support is not specifically defined. Preferably, the metal support is formed of SUS (for example, SUS 316).

In solution casting for formation of the cellulose acylate film of the invention, preferably, the organic acid represented by the above-mentioned general formula (1) is localized on one film surface side from the viewpoint of enhancing the peelability of the film. As the method for localizing the organic acid represented by the general formula (1) in solution casting for film formation, there are the first embodiment and the second embodiment of the invention.

### Casting Step in First Embodiment

In the first embodiment of the production method of the invention, the core layer solution containing a cellulose acylate (in which, however, the content of the organic acid represented by the general formula (1) is at most 3% by mass of the cellulose acylate), and the support-side layer solution containing a cellulose acylate and an organic acid represented by the general formula (1) in an amount of from 0.1% by mass to 20% by mass of the cellulose acylate are simultaneously or successively multilayer-cast on a support; and in this, at least 90% by mass of the cellulose acylate contained in the core layer solution and the support-side layer solution has a total degree of acyl substitution of from 1.5 to 2.7, and the core layer solution and the support-side layer solution are so controlled that the casting thickness of the support-side layer solution is at least 0.5% of the total casting thickness of the core layer solution and the support-side layer solution.

In the first embodiment of the production method of the invention, preferably employed is a multilayer-casting method such as a co-casting method, a successive casting method, a coating method or the like, but more preferred is a simultaneous co-casting method from the viewpoint of stable production and production cost cutting. In the multilayer casting method, preferably, the organic acid represented by the general formula (1) is added to only the support-side layer solution.

In case where the film is produced according to a co-casting method or a successive casting method, first, the cellulose acetate solutions (dopes) for the respective layers are prepared. In the co-casting method (multilayer simultaneous casting method), co-casting dopes are simultaneously extruded out through a casting Giesser through which the individual casting dopes for the intended layers (the layers may be three or more layers) are simultaneously cast via different slits onto a casting support (band or drum), and at a suitable time, the film formed on the support is peeled away and dried. FIG. 2 is a cross-sectional view showing a mode of simultaneous extrusion to form three layers by casting the dope 1 for surface layer and the dope 2 for core layer on a casting support 4 through a co-casting Giesser 3.

In case where multiple cellulose acylate solutions are cast, the cellulose acylate-containing solutions may be cast via multiple casting mouths arranged at intervals in the metal support running direction, and laminated to form a film. For this, for example, employable are the methods described in JP-A 61-158414, 1-122419 and 11-198285. The cellulose acylate solutions may be cast via two casting mouths for film formation. For this, for example, employable are the methods described in

JP-B 60-27562, JP-A 61-94724, 61-947245, 61-104813, 61-158413 and 6-134933. Also employable here is a casting method for cellulose acylate film, comprising enveloping a flow of a high-viscosity cellulose acylate solution with a low-viscosity cellulose acylate solution so as to simultaneously extrude out the high/low-viscosity cellulose acylate solutions, as in JP-A 56-162617. In addition, an embodiment where the outer side solution contains a larger amount of an alcohol ingredient acting as a poor solvent, than the inner side solution, as in JP-A 61-94724 and 61-94725, is also preferred here.

Another method is also employable here, in which two casting mouths are used for film formation, a film formed on a support through the first casting mouth is peeled, and another film is cast onto the metal support-facing side of the previously formed film by second casting thereon. For example, there may be mentioned the method described in JP-B 44-20235. Not specifically defined, the casting cellulose acylate solutions may be the same solution or may different cellulose acylate solutions. In order to make the formed multiple cellulose acylate layers have different functions, various cellulose acylate solutions corresponding to the intended functions may be extruded out via the casting mouths. Further, the cellulose acylate solutions for use in the invention may be co-cast along with any other functional layers (for example, adhesive layer, dye layer, antistatic layer, antihalation layer, UV absorbent layer, polarization layer, etc.).

The successive casting method is as follows: First the dope for the first layer is extruded out and cast onto a casting support through a casting Giesser, then after it is dried or not dried, the casting dope for the second layer is cast onto it in a mode of extrusion through a casting Giesser, and if desired, three or more layers are successively formed in the same mode of casting and lamination, and at a suitable time, the resulting laminate film is peeled away from the support and dried. The coating method is generally as follows: A film of a core layer is formed according to a solution casting method, then a coating solution for surface layer is prepared, and using a suitable coater, the coating solution is applied onto the previously formed core film first on one surface thereof and next on the other surface thereof, or simultaneously on both surfaces thereof, and the resulting laminate film is dried.

In the first embodiment of the production method of the invention, where the organic acid represented by the general formula (1) is localized on one film surface at the time of solution casting for film formation, the production method is preferably such that dopes of at least two or more layers are co-cast onto the metal support and the organic acid represented by the general formula (1) is added only to the dope for the support-side layer in an amount of from 0.1% by mass to 20% by mass of the cellulose acylate in the dope. Adding the organic acid represented by the general formula (1) to only the support-side layer solution for the layer to face the support in the amount falling within the above-mentioned range significantly enhances the peelability of the film from the support. Further, the peelability-enhancing function is concentrated in the thin skin B layer that faces the support while the content of the organic acid to be in the solution for the thick core layer not in direct contact with the support is reduced as much as possible, whereby the negative influence of the organic acid represented by the general formula (1) on the optical expressibility of the formed film and on the haze thereof can be suppressed.

In the first embodiment of the production method of the invention, the organic acid represented by the general formula (1) is contained in the solution for the support-side layer to form the thin skin B layer, in an amount of from 0.1% by mass to 20% by mass of the cellulose acylate in the solution, and the casting thickness of each of the support-side layer solution and the core layer solution must be so controlled that the content of the organic acid to be contained in the formed film could be from 0.01% by mass to less than 1% by mass of the cellulose acylate. Specifically, in the first embodiment of the production method of the invention, the casting solutions are so controlled that the ratio of the casting thickness of the support-side layer solution to the total casting thickness of the core layer solution and the support-side layer solution could be at least 0.5%.

The casting thickness of the support-side layer solution and the core layer solution is not specifically defined except that the thickness of each layer satisfies the above-mentioned range; however, preferably, the thickness of each layer of the formed film could fall within the preferred range of the thickness of the laminate of two or more layers of the film of the invention.

Preferably, the amount of the organic acid of the general formula (1) to be added to the support-side layer solution is from 1 to 10% by mass of the cellulose acylate in the solution, more preferably from 2 to 5% by mass.

In the first embodiment of the production method of the invention, it is necessary that the content of the organic acid of the general formula (1) in the core layer solution is at most 3% by mass of the cellulose acylate therein in order that the amount of the organic acid to be in the formed film could fall within the range defined in the invention and in order to reduce the haze of the film.

### Casting Step in Second Embodiment

In the second embodiment of the production method of the invention, the organic acid solution containing the organic acid of the general formula (1) is applied onto a support in such a manner that the organic acid of general formula (1) could be in an amount of from 0.001 mg/cm² to 0.8 mg/cm², and thereafter the solution containing a cellulose acylate having a degree of acyl substitution of from 1.5 to 2.7 is cast onto the organic acid solution.

The method of casting the organic acid solution onto a support is not specifically defined, for which is employable any known solution applying method. Above all, preferred is a method of at least one mode of coating and spraying. As the coating method, employable here is the same method for applying a cellulose acylate solution onto a support as in JP-A 61-158414, 1-122419 or 11-198285.

In the second embodiment of the production method of the invention, the organic acid solution is previously applied onto the support in the amount falling within the above-mentioned range, and accordingly, the peelability from the support of the film of the cellulose acylate having a low degree of acyl substitution to be formed by further casting thereon can be significantly enhanced.

In addition, in the production method, the organic acid represented by the general formula (1), which poorly corrodes metal as compared with any other inorganic acid or organic acid heretofore added in the art from the viewpoint of improving various properties of cellulose acylate films, is used, and therefore, even though the second embodiment of the invention where the acid is previously applied to the support is employed, the production apparatus can be prevented from deteriorating. As a result, the production cost for the film of the invention can be reduced.

In the second embodiment of the production method of the invention, preferably, the cellulose acylate solution to be cast on the organic acid solution having been applied to the support does not contain the organic acid of the general formula (1), from the viewpoint of reducing the content of the organic acid of the general formula (1) to be contained in the formed film and suppressing the negative influence of the organic acid on the optical expressibility of the formed film and on the haze thereof.

In the second embodiment of the production method of the invention, the organic acid solution is applied to the support in such a manner that the organic acid of the general formula (1) could be in an amount of from 0.001 mg /cm² to 0.8 mg/cm² on the support, but preferably, the casting thickness of the cellulose acylate solution is so controlled that the content of the organic acid to be contained in the formed film could be from 0.001% by mass to less than 0.1% by mass of the cellulose acylate in the film.

The amount of the organic acid solution to be applied to the support is preferably from 0.05 to 0.5 mg/cm², more preferably from 0.05 to 0.2 mg/cm².

### <Drying>

Preferably, the production method of the invention includes a step of drying the cellulose acylate laminate film and a step of stretching the dried cellulose acylate laminate film at a temperature not lower than (Tg-10° C.), from the viewpoint of enhancing the retardation of the film.

For drying the dope on a metal support in production of the cellulose acylate film of the invention, generally employable is a method of applying hot air to the surface of the metal support (drum or belt), or that is, onto the surface of the web on the metal support; a method of applying hot air to the back of the drum or belt; or a back side liquid heat transfer method that comprises contacting a temperature-controlled liquid with the opposite side of the dope-cast surface of the belt or drum, or that is, the back of the belt or drum to thereby heat the belt or drum by heat transmission to control the surface temperature thereof. Preferred is the backside liquid heat transfer method. The surface temperature of the metal support before the dope is cast thereon may be any degree so far as it is not higher than the boiling point of the solvent used in the dope. However, for promoting the drying or for making the dope lose its flowability on the metal support, preferably, the temperature is set to be lower by from 1 to 10° C. than the boiling point of the solvent having the lowest boiling point of all the solvents in the dope. In case where the cast dope is peeled off after cooled but not dried, then this shall not apply thereto.

### <Peeling>

The production method of the invention preferably includes a step of peeling the dope film from the metal support. The peeling method in the cellulose acylate film production method is not specifically defined. Any known method is employable here for enhancing the peelability of the film.

For controlling the thickness of the film, the solid concentration in the dope, the slit gap of the die nozzle, the extrusion pressure from the die, and the metal support speed may be suitably regulated so that the formed film could have a desired thickness.

In production of the film of the invention, preferably, the web (film) peeled from the support is stretched at the time when the residual solvent amount in the web is less than 120% by mass.

The residual solvent amount can be represented by the following formula:

Residual Solvent Amount (% by mass)={(M−N)/N}×100,

wherein M indicates the mass of the web at an arbitrary time, and N indicates the mass of the same web after dried at 110° C. for 3 hours.

When the residual solvent amount in the web is too large, then stretching the web maybe ineffective; but when too small, then stretching the web would be extremely difficult and the web may break. A more preferred range of the residual solvent amount in the web is at most 70% by mass, even more preferably from 10% by mass to 50% by mass, still more preferably from 12% by mass to 35% by mass. When the draw ratio in stretching is too small, then sufficient retardation could not be attained; but when too large, then stretching the web would be difficult and the web may break.

Preferably, the draw ratio is from 5% to 100%, more preferably from 15% to 40%, even more preferably from 20% to 35%. Here, stretching in one direction by from 5% to 100% means that the distance between the clips or the pins that hold the film is increased by from 1.05 to 2.00 times relative to the distance therebetween before stretching.

Stretching may be attained in the film traveling direction (machine direction) or in the direction transverse to the film traveling direction (transverse direction), or in the two directions. Preferably, the cellulose acylate film of the invention is obtained by stretching the film in the direction transverse to the film traveling direction, and the draw ratio is from 5% to 100% in the direction transverse to the film traveling direction. The more preferred range of the draw ratio in the direction transverse to the film traveling direction is the same as the above-mentioned range. When the draw ratio is at least 5%, then the stretched film can more suitably express Re and can be prevented from bowing. When the draw ratio is at most 50%, then the haze of the stretched film could be low.

In the invention, the film formed through solution-casting film formation and having a residual solvent amount falling within a specific range can be stretched even though it is not heated at high temperatures; however, stretching the film with drying is preferred as shortening the process. In the invention, the stretching temperature in the stretching step is preferably from 110 to 190° C., more preferably from 120 to 150° C. The stretching temperature not lower than 120° C. is preferred from the viewpoint of lowering the haze of the film; and the stretching temperature not higher than 150° C. is preferred from the viewpoint of enhancing the optical expressibility of the film (that is, for thinning the film).

On the other hand, when the web temperature is too high, then the plasticizer therein may evaporate away; and therefore in case where a volatile low-molecular plasticizer is used, the stretching temperature is preferably within a range of from room temperature (15° C.) to 145° C.

Stretching in two directions perpendicular to each other is effective from the viewpoint of enhancing the optical expressibility of the film, especially from the viewpoint of increasing the Rth value of the film. Preferably, the cellulose acylate film of the invention is obtained by simultaneous or successive stretching both in the direction parallel to the film traveling direction and in the direction transverse to the film traveling direction, and preferably, the draw ratio in the direction parallel to the film traveling direction is from 1% to 30%, more preferably from 3% to 20%, even more preferably from 5% to 10%. On the other hand, the draw ratio in the direction transverse to the film traveling direction is preferably from 5% to 100%, more preferably from 20% to 50%, even more preferably from 25% to 45%. The more preferred range of the draw ratio in the direction transverse to the film traveling direction is the same as the above-mentioned range.

In general, in case where a film is stretched by from 5% to 100% in the direction perpendicular to the film traveling direction (crosswise direction) using a biaxial stretching tenter, a contraction force is given to the film in the direction perpendicular to the crosswise direction, or that is, in the direction parallel to the film traveling direction (longitudinal direction).

Accordingly, when a film is kept stretched while the force is kept given thereto in one direction alone, then the width of the film in the direction perpendicular to that one direction would shrink, and this means controlling the shrinking amount relative to the shrinking amount with no width control, and means that the distance between the clips or the pins for width control is controlled to fall within a range of from 1.05 to 2.00 times relative to the width therebetween before stretching. In this, a force to shrink the film is given to the film in the lengthwise direction owing to the stretching in the crosswise direction. By controlling the distance between the clips or the pins in the lengthwise direction, the film is so protected that any unnecessary tension is not given thereto in the lengthwise direction. The web stretching method is not specifically defined here. For example, there are mentioned a method where multiple rolls are prepared and are controlled to have a different peripheral speed, and the film is made to run through the rolls and is thereby stretched in the lengthwise direction by utilizing the difference in the peripheral speed between the rolls; a method where both sides of the web are held by clips or pins and the distance between the clips or the pins is expanded in the running direction to thereby stretch the film in the lengthwise direction; or a method where the clips or the pins are expanded both in the lengthwise direction and in the crosswise direction to thereby stretch the film in both the lengthwise direction and the crosswise direction. Needless to say, these methods may be combined here. In the tenter method, preferably, the clips are driven according to a linear drive system, since the film can be stretched smoothly and since the risk of film breakage can be reduced.

In the invention, the film may be stretched simultaneously or successively in two directions in the stretching step. In case where the film is stretched successively in two directions, the stretching temperature may be varied in stretching in each direction.

In case where the film is stretched simultaneously in two directions, the stretching temperature may fall within a range of from 110° C. to 190° C. to produce the film of the invention. More preferably, the stretching temperature for the simultaneous two-axial stretching is from 120° C. to 150° C., more preferably from 130° C. to 150° C. Simultaneous biaxial stretching may increase the haze of the stretched film in some degree, but can further enhance the optical expressibility of the film.

On the other hand, in successive biaxial stretching, preferably, the film is first stretched in the direction parallel to the film traveling direction and then stretched in the direction transverse to the film traveling direction. The more preferred range of the stretching temperature for the successive stretching is the same as the stretching temperature range for the simultaneous biaxial stretching mentioned above.

### (Heat Treatment Step)

Preferably, the film of the invention is given a heat treatment step after the drying step. The heat treatment in the heat treatment step may be attained after the drying step, or may be attained directly after the stretching/drying step, or after the film is once wound up according to the method mentioned below after the drying step, a separate heat treatment step may be given later to the film. Preferably, in the invention, the film is once cooled to room temperature to 100° C. or lower after the drying step, and thereafter the film is separately processed in the heat treatment step given later thereto. This mode is advantageous from the viewpoint of obtaining a film having more excellent thermal dimensional stability. For the same reason, it is also desirable that the film is dried to have a residual solvent content of less than 2% by mass, more preferably less than 0.4% by mass, just before the heat treatment step.

The reason why the film shrinkage could be reduced owing to the treatment as above is not clear, but could be presumed as follows: In the film stretched in the stretching step, the residual stress in the stretching direction is large, and the residual stress in the film is solved by the heat treatment, and as a result, the shrinking force of the film in the region not higher than the heat treatment temperature could be thereby reduced.

The heat treatment may be attained according to a method of applying air at a predetermined temperature to the traveling film, or a method of using a heating means such as microwaves or the like.

Preferably, the heat treatment is attained at a temperature of from 150 to 200° C., more preferably from 160 to 180° C. Also preferably, the heat treatment time is from 1 to 20 minutes, more preferably from 5 to 10 minutes.

When the film is heated for a long time at a temperature higher than 200° C., then there may occur a problem in that the plasticizer contained in the film may evaporate too much and the amount thereof scattering in air may increase.

In the heat treatment step, the film shrinks in the lengthwise direction or the crosswise direction. Preferably, the heat treatment is so controlled that the shrinkage is reduced as much as possible in order that the surface planarity of the finished film could be bettered. For this, preferred is a method of attaining the heat treatment while both sides of the web are clipped or pinned in the widthwise direction to thereby constantly secure the width of the film (tenter system).

In the heat treatment step, the film may be stretched at high temperatures separately from the above-mentioned stretching step. The draw ratio in stretching is preferably from 5% to 100%, more preferably from 15% to 40%, even more preferably from 20% to 35%.

The film may be stretched in the film traveling direction (lengthwise direction), or in the direction transverse to the film traveling direction (transverse direction), or in both the two directions. Preferably, the cellulose acylate film of the invention is produced by stretching it in the direction transverse to the film traveling direction, and the draw ratio is from 5% to 100% in the direction transverse to the film traveling direction. The more preferred range of the draw ratio in the direction transverse to the film traveling direction is the same as the above-mentioned range. When the draw ratio is at least 5%, then the stretched film can more suitably express Re and can be prevented from bowing. When the draw ratio is at most 50%, then the haze of the stretched film could be low.

The stretching temperature in the heat treatment step is the same as the above-mentioned heat treatment temperature range. The stretching temperature not lower than 140° C. is preferred from the viewpoint of lowering the haze of the film; and the stretching temperature not higher than 190° C. is preferred from the viewpoint of enhancing the optical expressibility of the film (that is, for thinning the film).

Stretching the film in two directions perpendicular to each other is effective from the viewpoint of enhancing the optical expressibility of the film, especially from the viewpoint of increasing the Rth value of the film. Preferably, the cellulose acylate film of the invention is obtained by simultaneous or successive stretching both in the direction parallel to the film traveling direction and in the direction transverse to the film traveling direction, and preferably, the draw ratio in the direction parallel to the film traveling direction is from 1% to 30%, more preferably from 3% to 20%, even more preferably from 5% to 10%. On the other hand, the draw ratio in the direction transverse to the film traveling direction is preferably from 5% to 100%, more preferably from 20% to 50%, even more preferably from 25% to 45%.

In the invention, the film may be stretched simultaneously in two directions in the stretching step, or may be successively in two directions therein. In case where the film is stretched successively in two directions, the stretching temperature may be varied for each stretching in each direction.

In case where the film is stretched simultaneously in two directions, the preferred stretching temperature range is the same as the above-mentioned heat treatment temperature range. Simultaneous biaxial stretching may increase the haze of the stretched film in some degree, but can further enhance the optical expressibility of the film.

On the other hand, in successive biaxial stretching, preferably, the film is first stretched in the direction parallel to the film traveling direction and then stretched in the direction transverse to the film traveling direction. The more preferred range of the stretching temperature for the successive stretching is the same as the above-mentioned heat treatment temperature range.

As the winder for winding the formed film, herein usable is any winder generally used in the art. Briefly, the film can be wound up according to various winding methods, for example, according to a constant tension method, a constant torque method, a tapered tension method, or a programmed tension control method where the internal stress is kept constant. Preferably, the optical film roll thus produced in the manner as above is such that the slow axis direction thereof is tilted by ±2 degrees relative to the winding direction (film length direction), more preferably by ±1 degree. Also preferably, the slow axis direction of the film is tilted by ±2 degrees relative to the direction perpendicular to the winding direction (film width direction), more preferably by ±1 degree. Especially preferably, the slow axis direction of the film is tilted by ±0.1 degrees relative to the winding direction (film length direction). Also preferably, the slow axis direction of the film is tilted by ±0.1 degrees relative to the film width direction.

### [Hot Steam Treatment]

The stretched film may be subsequently processed in a step of spraying thereon steam heated at 100° C. or higher. The steam spraying step is favorable as capable of relaxing the residual stress in the produced cellulose acylate film and capable of reducing the dimensional change of the film. With no problem, the steam temperature may be 100° C. or higher, but in consideration of the heat resistance of the film, the steam temperature is preferably not higher than 200° C.

The process from casting to post-drying may be attained in an air atmosphere or in an inert gas atmosphere such as nitrogen gas or the like. The winder for use in producing the cellulose acylate film of the invention is any winder generally used in the art. Briefly, the film can be wound up according to various winding methods, for example, according to a constant tension method, a constant torque method, a tapered tension method, or a programmed tension control method where the internal stress is kept constant.

Regarding the length thereof, the cellulose acylate film of the invention thus produced in the manner as above is preferably wound up into a roll having a length of from 100 to 10000 m, more preferably from 500 to 7000 m, even more preferably from 1000 to 6000 m. In winding up the film, preferably, the film is knurled at least on one side thereof, and the knurling width is preferably from 3 mm to 50 mm, more preferably from 5 mm to 30 mm, and the knurling height is preferably from 0.5 to 500 μm, more preferably from 1 to 200 μm. The knurling may be in a mode of single pressing or double pressing.

In general, in a large-panel display device, the contrast reduction and the color shift in oblique directions are often remarkable, and therefore, the film of the invention is especially suitable for use in large-panel liquid crystal display devices. In case where the film is used as an optical compensatory film for large-panel liquid crystal display devices, preferably, the film is shaped to have a film width of, for example, at least 1470 mm. The cellulose acylate film of the invention includes not only an embodiment of a film sheet cut in a size capable of being directly incorporated in a liquid crystal display device but also an embodiment of a film roll produced as a long film in continuous production and wound up into a roll. The cellulose acylate film of the latter embodiment is stored and conveyed as it is, and when it is in fact incorporated into a liquid crystal display device or when it is stuck to a polarizing element or the like, it may be cut into a sheet having a desired size. The film of the invention formed as a long film may be stuck, directly as it is, with a polarizing element formed of a polyvinyl alcohol film or the like similarly as a long film, and thereafter when the thus-stuck films are in fact incorporated in a liquid crystal display device, they may be cut into a desired size. One embodiment of the cellulose acylate film wound up in the form of a roll may have a roll length of at least 2500 m.

### [Polarizer]

The invention also relates to a polarizer using at least one film of the invention.

Preferably, the polarizer of the invention contains a polarizing element and the film of the invention on at least one side of the polarizing element. Like the cellulose acylate film of the invention, the polarizer of the invention also includes not only an embodiment of a film sheet cut in a size capable of being directly incorporated in a liquid crystal display device but also an embodiment of a film roll produced as a long film in continuous production and wound up into a roll (for example, an embodiment having a roll length of at least 2500 m or at least 3900 m). For use in large-panel liquid crystal display devices, the width of the polarizer is preferably at least 1470 mm, as so mentioned in the above.

For the concrete constitution of the polarizer of the invention, any known constitution is employable with no limitation thereon. For example, the constitution described in FIG. 6 in JP-A 2008-262161 may be employed here.

### [Liquid Crystal Display Device]

The invention also relates to a liquid crystal display device having the polarizer of the invention.

The liquid crystal display device of the invention comprises a liquid crystal cell and a pair of polarizers arranged on both sides of the liquid crystal cell, in which at least one polarizer is the polarizer of the invention. Preferably, the liquid crystal display device is an IPS, OCB or VA-mode liquid crystal display device.

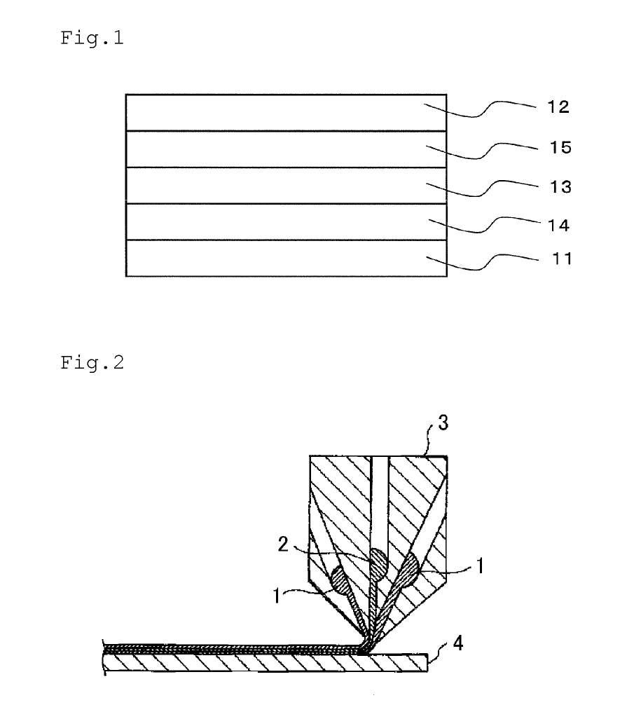

The concrete constitution of the liquid crystal display device of the invention is not specifically defined, and any known constitution is employable therein. For example, one example of the constitution of the liquid crystal display device of the invention is shown in FIG. 1. In addition, the constitution described in FIG. 2 in JP-A 2008-262161 is also employable here.

### EXAMPLES

The invention is described more concretely with reference to the following Examples, in which the material and the reagent used, their amount and ratio, the details of the treatment and the treatment process may be suitably modified or changed not overstepping the sprit and the scope of the invention. Accordingly, the scope of the invention should not be restricted to the Examples mentioned below.

### Example 1

### Preparation of Cellulose Acylate

Cellulose acylates were produced according to the methods described in JP-A 10-45804, 08-231761, JP-T 2010-529216, and analyzed for the degree of substitution thereof. Concretely, as a catalyst, sulfuric acid (7.8 parts by mass relative to 100 parts by mass of cellulose) was added, and a carboxylic acid to be the starting material for the acyl substituent was added for acylation at 40° C. In this stage, the type and the amount of the carboxylic acid were changed and controlled to change and control the type of the acyl group and the degree of substitution. After the acylation, the system was aged at 40° C. Further, the system was washed with acetone to remove the low-molecular ingredient of cellulose acylate.

### Preparation of Cellulose Acylate Solution for Support-Side Layer

The following ingredients were put into a mixing tank and dissolved by stirring to prepare a cellulose acylate solution having a solid concentration of 22% by mass. The viscosity of the cellulose acylate solution was 60 Pa·s.

| | |
|---|---|
| Cellulose acetate (degree of substitution, 2.42) | 100.0 parts by mass |
| Polycondensate polyester D | 10.0 parts by mass |
| Riken Vitamin's Poem K-37V | 2.0 parts by mass |
| Methylene chloride | 365.5 parts by mass |
| Methanol | 54.6 parts by mass |

The polycondensate polyester D is a terephthalic acid/succinic acid/1,2-propanediol/ethylene glycol copolymer (copolymerization ratio (by mol)=35/15/25/25), and has a molecular weight of 700 with the terminate being protected with acetic acid.

### Preparation of Cellulose Acylate Solution for Core Layer

The following ingredients were put into a mixing tank and dissolved by stirring to prepare a cellulose acylate solution having a solid concentration of 22% by mass. The viscosity of the cellulose acylate solution was 60 Pa·s.

| | |
|---|---|
| Cellulose acetate (degree of substitution, 2.42) | 100.0 parts by mass |
| Polycondensate polyester D | 10.0 parts by mass |
| Retardation enhancer L | 2.0 parts by mass |
| Methylene chloride | 365.5 parts by mass |
| Methanol | 54.6 parts by mass |

The retardation enhancer L is a compound having the following structure:

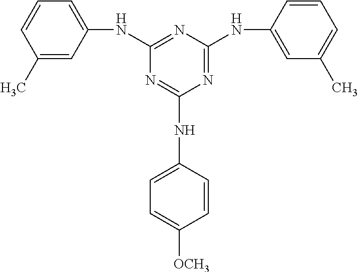

### Production of Cellulose Acylate Film

The cellulose acylate solution for core layer was cast to form a layer having a thickness of 57 μm and the cellulose acylate solution support-side layer was cast to form a skin B layer (outermost layer on the side of metal support) having a thickness of 3 μm. The formed web (film) was peeled from the band and clipped, and while the residual solvent amount in the film was from 20 to 5% by mass of the entire mass of the film, this was laterally stretched by 1.08 times at 140° C. using a tenter. Next, the film was unclipped, dried at 130° C. for 20 minutes, and further using a tenter, this was again laterally stretched by 1.2 times at 180° C., thereby producing a cellulose acylate film of the invention.

The residual solvent amount was computed according to the following formula:

Residual Solvent Amount (% by mass)={(M−N)/N}×100,

wherein M indicates the mass of the web at an arbitrary time, and N indicates the mass of the same web after dried at 120° C. for 2 hours.

### <Evaluation>

### (Total Mean Content of Organic Acid)

The amount of the organic acid contained in the obtained cellulose acylate film was measured according to the method mentioned below.

The film was dissolved in a solvent of heavy acetone to prepare a solution of around 10 mg/cc. The solution was analyzed with a nuclear magnetic resonator (NMR) to give a proton NMR spectrum. The peak intensity ratio of the peak derived from the benzene ring contained in the polycondensate polyester to the organic acid-derived peak was determined, from which the organic acid amount in the cellulose acylate film was computed.

### [Ratio of Organic Acid Concentration on Both Surfaces]

The amount of the organic acid contained in the film surface was determined according to the method mentioned below; and according to the formula mentioned below, the concentration ratio of organic acid was computed. The results are all shown in Table 5 below.

The film was cut obliquely at an angle of 1° relative to the film face, and the resulting film cross section was mapped with a time-of-flight secondary ion mass spectrometer (TOF-SIMS). The mean value of the peak intensity of the molecule +H⁻ ion in positive measurement in the part corresponding to the depth of up to 2 μm from the surface on the face A side, and the mean value of the peak intensity of the molecule +H⁻ ion in the part corresponding to the depth of up to 2 μm from the surface on the face B side were determined, and the concentration ratio Xa/Xb of the organic acid was computed according to the following formula:

Concentration Ration Xa/Xb=(mean vale of peak intensity on the side having higher organic acid concentration)/(mean vale of peak intensity on the side having lower organic acid concentration).

### (Recyclability)

The film recyclability was evaluated according to the method and the criteria mentioned below.

The formed film was ground into chips, and a core layer solution was prepared to have the same solid concentration and the same solvent composition as in the cellulose acylate solution for core layer in Example 1. A support-side layer solution was prepared newly according to the method for the cellulose acylate solution for support-side layer in Example 1, not using the chips. According to the method for producing the cellulose acylate film in Example 1, these solutions were again cast to form a core layer having a thickness of 57 μm and a skin B layer having a thickness of 3 μm, and stretched. The cycle was again repeated, and depending on the degree of whitening of the finished film, the film recyclability was evaluated according to the following criteria.
1: No partial whitening was seen in the film and the film was uniformly transparent.
2: Partial whitening was seen in the film.
3: The film surface whitened entirely.

The obtained results are shown in Table 5 below.

### (Peelability Evaluation)

The in-line mixed dope that had been prepared in Example 1 was cast onto a smooth stainless steel plate (support) to be a thickness of about 1 mm, then left at room temperature for 4 minutes, and the peelability thereof was evaluated according to the following criteria.
A: With no peeling resistance, the film peeled smoothly and the film surface was smooth.
B: The film peeled though having some resistance to peeling, and the film surface was smooth. However, there was a problem of peeling unevenness of film.
C: The peeling resistance was great, and the film did not peel. In addition, film peel residues remained on the stainless steel plate.

The evaluation results are shown in Table 5 below.

In the following Table 5, the amount added and the content of the organic acid is in terms of the amount of the acid (% by mass) relative to 100 parts by mass of cellulose acylate.

### (Optical Expressibility)

The produced cellulose acylate film was conditioned at 25° C. and at a relative humidity of 60% for 2 hours or more, and analyzed for Re and Rth thereof at a wavelength of 590 nm, at 25° C. and at a relative humidity of 60%, using an automatic birefringence meter (KOBRA 21ADH, by Oji Scientific Instruments). The obtained results are shown in Table 5 below.

### (Total Haze, Internal Haze)

A sample 40 mm×80 mm of the produced cellulose acylate film was analyzed for the total haze and the internal haze thereof at 25° C. and at a relative humidity of 60%, using a haze meter “HGM-2DP” (by Suga Test Instruments] according to JIS K-6714. The results are shown in Table 5.

### Examples 2 to 16, Comparative Examples 1 to 8

Cellulose acylate films of other Examples and Comparative Examples were produced in the same manner as in Example 1 except that the type of the cellulose acylate used and the amount of the organic acid added to each dope were changed as in Table 5 below. The produced films were evaluated in the same manner as in Example 1, and the results are shown in Table 5.

In Example 6, used was cellulose acylate propionate having a total degree of acyl substitution of 1.71, a degree of acetyl substitution of 0.17 and a degree of propionyl substitution of 1.54. In Example 7, used was cellulose acylate propionate having a total degree of acyl substitution of 1.98, a degree of acetyl substitution of 0.53 and a degree of propionyl substitution of 1.45. In Example 8, used was cellulose acylate propionate having a total degree of acyl substitution of 2.50, a degree of acetyl substitution of 1.60 and a degree of propionyl substitution of 0.90. In Comparative Example 1, used was cellulose acetate having a total degree of acyl substitution of 2.82 and a degree of acetyl substitution of 2.82. In the following Table 5, cellulose acetate was represented by CA, and cellulose acylate propionate was by CAP.

In Comparative Example 6, a solution having the same composition as that of the support-side layer cellulose acylate solution in Example 1 was prepared as the air-side layer cellulose acylate solution, and the film was produced by three-layer co-casting of the solutions.

In Examples 9 and 10, an organic acid (0.1% by mass) solution was prepared, using a mixed solvent of methylene chloride and methanol in the same ratio by weight as that for the support-side layer cellulose acylate solution in Example 1. The solution was previously applied onto the support before the cellulose acylate solution was applied thereonto, and dried, whereby the organic acid in the amount shown in Table 5 below was given to the film.

In Example 14, the same organic acid (0.1% by mass) solution as in Examples 9 and 10 was prepared, and sprayed onto the support as extruded out through a porous substrate, whereby the organic acid in the amount shown in Table 5 below was given to the film.

In Example 15, cellulose acylate film was produced in the same manner as in Example 1 except that the thickness of the core layer was 46 μm and the film was stretched by 1.22 times at 180° C. using a tenter after drying at 130° C. for 20 minutes.

In Example 16, cellulose acylate film was produced in the same manner as in Example 1 except that the thickness of the core layer was 38 μm and the film was stretched by 1.25 times at 180° C. using a tenter after drying at 130° C. for 20 minutes.

### Examples 17 and 18

### Preparation of Cellulose Acylate Solution for Support-Side Layer

The following ingredients were put into a mixing tank and dissolved by stirring to prepare a cellulose acylate solution having a solid concentration of 22% by mass. The viscosity of the cellulose acylate solution was 50 Pa·s.

| | |
|---|---|
| Cellulose acetate (degree of substitution, 2.42) | 100.0 parts by mass |
| Polycondensate polyester E | 19.0 parts by mass |
| Riken Vitamin's Poem K-37V | 2.0 parts by mass |
| Methylene chloride | 365.5 parts by mass |
| Methanol | 54.6 parts by mass |

The polycondensate polyester D is a terephthalic acid/succinic acid/1,2-propanediol/ethylene glycol copolymer (copolymerization ratio (by mol)=27.5/22.5/25/25), and has a molecular weight of 700 with the terminate being protected with acetic acid.

### Preparation of Cellulose Acylate Solution for Core Layer

The following ingredients were put into a mixing tank and dissolved by stirring to prepare a cellulose acylate solution having a solid concentration of 22% by mass. The viscosity of the cellulose acylate solution was 50 Pa·s.

| | |
|---|---|
| Cellulose acetate (degree of substitution, 2.42) | 100.0 parts by mass |
| Polycondensate polyester E | 19.0 parts by mass |
| Retardation enhancer L | 1.3 parts by mass |
| Methylene chloride | 365.5 parts by mass |
| Methanol | 54.6 parts by mass |

### Production of Cellulose Acylate Film

The cellulose acylate solution for core layer was cast to form a layer having a thickness of 56 μand the cellulose acylate solution support-side layer was cast to form a skin B layer (outermost layer on the side of metal support) having a thickness of 3 μm. The formed web (film) was peeled from the band and clipped, and while the residual solvent amount in the film was from 20 to 5% by mass of the entire mass of the film, this was laterally stretched by 1.08 times at 140° C. using a tenter. Next, the film was unclipped, dried at 130° C. for 20 minutes, and further using a tenter, this was again laterally stretched by 1.22 times at 180° C. in Example 17 and by 1.22 times at 170° C. in Example 18, thereby producing a cellulose acylate film of the invention.

### Example 19

### Preparation of Cellulose Acylate Solution for Support-Side Layer

The following ingredients were put into a mixing tank and dissolved by stirring to prepare a cellulose acylate solution having a solid concentration of 20.5% by mass. The viscosity of the cellulose acylate solution was 50 Pa·s.

| | |
|---|---|
| Cellulose acetate (degree of substitution, 2.42) | 100.0 parts by mass |
| Sugar ester A-5 | 8.0 parts by mass |
| Polycondensate polyester F | 3.0 parts by mass |
| Riken Vitamin's Poem K-37V | 2.0 parts by mass |
| Methylene chloride | 365.5 parts by mass |
| Methanol | 54.6 parts by mass |

The polycondensate polyester F is a terephthalic acid/1,2-propanediol (copolymerization ratio (by mol)=50/50), and has a molecular weight of 500 with the terminate being protected with benzoic acid.

### Preparation of Cellulose Acylate Solution for Core Layer

The following ingredients were put into a mixing tank and dissolved by stirring to prepare a cellulose acylate solution having a solid concentration of 20.5% by mass. The viscosity of the cellulose acylate solution was 50 Pa·s.

| | |
|---|---|
| Cellulose acetate (degree of substitution, 2.42) | 100.0 parts by mass |
| Sugar ester A-5 | 8.0 parts by mass |
| Polycondensate polyester F | 3.0 parts by mass |
| Methylene chloride | 365.5 parts by mass |
| Methanol | 54.6 parts by mass |

### Production of Cellulose Acylate Film

The cellulose acylate solution for core layer was cast to form a layer having a thickness of 56 μm and the cellulose acylate solution support-side layer was cast to form a skin B layer (outermost layer on the side of metal support) having a thickness of 3 μm. The formed web (film) was peeled from the band and clipped, and while the residual solvent amount in the film was from 20 to 5% by mass of the entire mass of the film, this was laterally stretched by 1.08 times at 140° C. using a tenter. Next, the film was unclipped, dried at 130° C. for 20 minutes, and further using a tenter, this was again laterally stretched by 1.22 times at 180° C., thereby producing a cellulose acylate film of the invention.

### Example 20

### Preparation of Cellulose Acylate Solution for Support-Side Layer

The following ingredients were put into a mixing tank and dissolved by stirring to prepare a cellulose acylate solution having a solid concentration of 20.5% by mass. The viscosity of the cellulose acylate solution was 50 Pa·s.

| | |
|---|---|
| Cellulose acetate (degree of substitution, 2.42) | 100.0 parts by mass |
| Sugar ester A-5 | 8.0 parts by mass |
| Polycondensate polyester G | 3.0 parts by mass |
| Riken Vitamin's Poem K-37V | 2.0 parts by mass |
| Methylene chloride | 365.5 parts by mass |
| Methanol | 54.6 parts by mass |

The polycondensate polyester G is a terephthalic acid/1,2-propanediol (copolymerization ratio (by mol)=50/50), and has a molecular weight of 500 with the terminate being protected with p-methylbenzoic acid.

### Preparation of Cellulose Acylate Solution for Core Layer

The following ingredients were put into a mixing tank and dissolved by stirring to prepare a cellulose acylate solution having a solid concentration of 20.5% by mass. The viscosity of the cellulose acylate solution was 50 Pa·s.

| | |
|---|---|
| Cellulose acetate (degree of substitution, 2.42) | 100.0 parts by mass |
| Sugar ester A-5 | 8.0 parts by mass |
| Polycondensate polyester G | 3.0 parts by mass |
| Methylene chloride | 365.5 parts by mass |
| Methanol | 54.6 parts by mass |

### Production of Cellulose Acylate Film

The cellulose acylate solution for core layer was cast to form a layer having a thickness of 56 μm and the cellulose acylate solution support-side layer was cast to form a skin B layer (outermost layer on the side of metal support) having a thickness of 3 μm. The formed web (film) was peeled from the band and clipped, and while the residual solvent amount in the film was from 20 to 5% by mass of the entire mass of the film, this was laterally stretched by 1.08 times at 140° C. using a tenter. Next, the film was unclipped, dried at 130° C. for 20 minutes, and further using a tenter, this was again laterally stretched by 1.22 times at 180° C., thereby producing a cellulose acylate film of the invention.

### Example 21

### Preparation of Cellulose Acylate Solution for Support-Side Layer

The following ingredients were put into a mixing tank and dissolved by stirring to prepare a cellulose acylate solution having a solid concentration of 20.5% by mass. The viscosity of the cellulose acylate solution was 50 Pa·s.

| | |
|---|---|
| Cellulose acetate (degree of substitution, 2.42) | 100.0 parts by mass |
| Sugar ester A-2 | 8.0 parts by mass |
| Polycondensate polyester G | 3.0 parts by mass |
| Riken Vitamin's Poem K-37V | 2.0 parts by mass |
| Methylene chloride | 365.5 parts by mass |
| Methanol | 54.6 parts by mass |

### Preparation of Cellulose Acylate Solution for Core Layer

The following ingredients were put into a mixing tank and dissolved by stirring to prepare a cellulose acylate solution having a solid concentration of 20.5% by mass. The viscosity of the cellulose acylate solution was 50 Pa·s.

| | |
|---|---|
| Cellulose acetate (degree of substitution, 2.42) | 100.0 parts by mass |
| Sugar ester A-2 | 8.0 parts by mass |
| Polycondensate polyester G | 3.0 parts by mass |
| Methylene chloride | 365.5 parts by mass |
| Methanol | 54.6 parts by mass |

### Production of Cellulose Acylate Film

The cellulose acylate solution for core layer was cast to form a layer having a thickness of 56 μm and the cellulose acylate solution support-side layer was cast to form a skin B layer (outermost layer on the side of metal support) having a thickness of 3 μm. The formed web (film) was peeled from the band and clipped, and while the residual solvent amount in the film was from 20 to 5% by mass of the entire mass of the film, this was laterally stretched by 1.08 times at 140° C. using a tenter. Next, the film was unclipped, dried at 130° C. for 20 minutes, and further using a tenter, this was again laterally stretched by 1.22 times at 175° C., thereby producing a cellulose acylate film of the invention.

TABLE 5

| | Production Process | | | | | | |
|---|---|---|---|---|---|---|---|
| | Support | Support-Side Layer Solution | | | | | |
| | Amount of | | | Amount of | Thickness | Core Layer Solution | |
| | Organic Acid | | | Organic Acid | of Unstretched | | Degree of |
| | Applied | Cellulose | Degree of Acyl | Added | Film | Cellulose | Acyl |
| | [mg/cm²] | Acylate | Substitution | [% by mass] | [μm] | Acylate | Substitution |
| Example 1 | none | CA | 2.42 | 2 | 3 | CA | 2.42 |
| Example 2 | none | CA | 2.42 | 4 | 3 | CA | 2.42 |
| Example 3 | none | CA | 2.42 | 15 | 3 | CA | 2.42 |
| Example 4 | none | CA | 2.42 | 2 | 3 | CA | 2.42 |
| Example 5 | none | CA | 2.42 | 2 | 1 | CA | 2.42 |
| Example 6 | none | CAP | 1.71 | 2 | 3 | CAP | 1.71 |
| Example 7 | none | CAP | 1.98 | 2 | 3 | CAP | 1.98 |
| Example 8 | none | CAP | 2.50 | 2 | 3 | CAP | 1.98 |
| Example 12 | none | CA | 2.42 | 2 | 3 | CA | 2.42 |
| Example 13 | none | CA | 2.42 | 2 | 1 | CA | 2.42 |
| Comparative | none | CA | 2.86 | 0 | 3 | CA | 2.42 |
| Example 1 | | | | | | | |
| Comparative | none | CA | 2.42 | 0 | 3 | CA | 2.42 |
| Example 2 | | | | | | | |
| Comparative | none | CA | 2.42 | 2 | 0.1 | CA | 2.42 |
| Example 3 | | | | | | | |
| Comparative | none | CA | 2.42 | 4 | 3 | CA | 2.42 |
| Example 4 | | | | | | | |
| Comparative | none | CA | 2.42 | 25 | 3 | CA | 2.42 |
| Example 5 | | | | | | | |
| Comparative | none | CA | 2.42 | 25 | 3 | CA | 2.42 |
| Example 8 | | | | | | | |
| Comparative | none | CA | 2.42 | 0 | 3 | CA | 2.42 |
| Example 6 | | | | | | | |
| Example 9 | 0.005 | CA | 2.42 | 0 | 3 | CA | 2.42 |
| Example 10 | 0.5 | CA | 2.42 | 0 | 3 | CA | 2.42 |
| Example 11 | 0.5 | none | | | | CA | 2.42 |
| Example 14 | 0.005 | CA | 2.42 | 0 | 3 | CA | 2.42 |
| Comparative | 3 | CA | 2.42 | 0 | 3 | CA | 2.42 |
| Example 7 | | | | | | | |
| Example 15 | none | CA | 2.42 | 2 | 3 | CA | 2.42 |
| Example 16 | none | CA | 2.42 | 2 | 3 | CA | 2.42 |
| Example 17 | none | CA | 2.42 | 2 | 3 | CA | 2.42 |
| Example 18 | none | CA | 2.42 | 2 | 3 | CA | 2.42 |
| Example 19 | none | CA | 2.42 | 2 | 3 | CA | 2.42 |
| Example 20 | none | CA | 2.42 | 2 | 3 | CA | 2.42 |
| Example 21 | none | CA | 2.42 | 2 | 3 | CA | 2.42 |

| | Production Process | | | | | |
|---|---|---|---|---|---|---|
| | Core Layer Solution | | Air-Side Layer Solution | | | |
| | Amount of | Thickness of | | | | Thickness of |
| | Organic Acid | Unstretched | | Degree of | Amount of Organic Acid | Unstretched |
| | Added | Film | | Acyl | Added | Film |
| | [% by mass] | [μm] | Cellulose Acylate | Substitution | [% by mass] | [μm] |
| Example 1 | 0 | 57 | — | — | — | — |
| Example 2 | 0 | 57 | — | — | — | — |
| Example 3 | 0 | 57 | — | — | — | — |
| Example 4 | 0.5 | 57 | — | — | — | — |
| Example 5 | 0 | 57 | — | — | — | — |
| Example 6 | 0 | 57 | — | — | — | — |
| Example 7 | 0 | 57 | — | — | — | — |
| Example 8 | 0 | 57 | — | — | — | — |
| Example 12 | 0 | 54 | CA | 2.42 | 2 | 3 |
| Example 13 | 0 | 54 | CA | 2.42 | 2 | 1 |
| Comparative | 0 | 57 | — | — | — | — |
| Example 1 | | | | | | |
| Comparative | 0 | 57 | — | — | — | — |
| Example 2 | | | | | | |
| Comparative | 0 | 57 | — | — | — | — |
| Example 3 | | | | | | |
| Comparative | 4 | 57 | — | — | — | — |
| Example 4 | | | | | | |
| Comparative | 25 | 57 | — | — | — | — |
| Example 5 | | | | | | |
| Comparative | 0 | 57 | — | — | — | — |
| Example 8 | | | | | | |
| Comparative | 0 | 54 | CA | 2.42 | 2 | 3 |
| Example 6 | | | | | | |
| Example 9 | 0 | 57 | — | — | — | — |
| Example 10 | 0 | 57 | — | — | — | — |
| Example 11 | 0 | 60 | — | — | — | — |
| Example 14 | 0 | 57 | CA | 2.42 | 2 | 1 |
| Comparative | 0 | 57 | — | — | — | — |
| Example 7 | | | | | | |
| Example 15 | 0 | 46 | — | — | — | — |
| Example 16 | 0 | 38 | — | — | — | — |
| Example 17 | 0 | 56 | — | — | — | — |
| Example 18 | 0 | 56 | — | — | — | — |
| Example 19 | 0 | 56 | — | — | — | — |
| Example 20 | 0 | 56 | — | — | — | — |
| Example 21 | 0 | 56 | — | — | — | — |

| | Formed Film | | | | | | | |
|---|---|---|---|---|---|---|---|---|
| | Organic Acid Content | | | | | | | |
| | | Content Ratio | | | | | | |
| | | around Both | | Evaluation | | | | |
| | | Surfaces | Thickness | | | Rth per | | |
| | Total Mean | low-content | after | | | unit | Total | |
| | Content | side/high-content | stretched | | | thickness | Haze | Inner Haze |
| | [% by mass] | side | [μm] | Peelability | Recyclability | [nm/μm] | [%] | [%] |
| Example 1 | 0.100 | 0.98 | 50 | A | 1 | 3.29 | 0.18 | 0.03 |
| Example 2 | 0.200 | 0.98 | 50 | A | 1 | 3.24 | 0.24 | 0.03 |
| Example 3 | 0.750 | 0.98 | 50 | A | 1 | 3.17 | 0.24 | 0.04 |
| Example 4 | 0.575 | 0.98 | 50 | A | 1 | 3.20 | 0.27 | 0.03 |
| Example 5 | 0.034 | 0.98 | 50 | A | 1 | 3.33 | 0.29 | 0.04 |
| Example 6 | 0.100 | 0.98 | 50 | A | 1 | 4.90 | 0.53 | 0.08 |
| Example 7 | 0.100 | 0.98 | 50 | A | 1 | 3.80 | 0.43 | 0.06 |
| Example 8 | 0.100 | 0.98 | 50 | A | 1 | 3.20 | 0.30 | 0.03 |
| Example 12 | 0.200 | 1.00 | 50 | A | 1 | 3.23 | 0.23 | 0.03 |
| Example 13 | 0.400 | 1.00 | 50 | A | 1 | 3.21 | 0.27 | 0.03 |
| Comparative | 0.000 | — | 50 | A | 3 | — | — | — |
| Example 1 | | | | | | | | |
| Comparative | 0.000 | — | 50 | C | 1 | 3.37 | 0.30 | 0.04 |
| Example 2 | | | | | | | | |
| Comparative | 0.004 | 0.99 | 50 | B | 1 | 3.37 | 0.20 | 0.04 |
| Example 3 | | | | | | | | |
| Comparative | 4.00 | 1.00 | 50 | A | 2 | 2.90 | 2.50 | 1.20 |
| Example 4 | | | | | | | | |
| Comparative | 25.0 | 1.00 | 50 | A | 3 | — | — | — |
| Example 5 | | | | | | | | |
| Comparative | 1.25 | 0.97 | 50 | A | 2 | 3.10 | 1.50 | 0.30 |
| Example 8 | | | | | | | | |
| Comparative | 0.100 | 0.83 | — | C | 1 | 3.29 | — | — |
| Example 6 | | | | | | | | |
| Example 9 | 0.049 | 0.95 | 50 | A | 1 | 3.32 | 0.29 | 0.04 |
| Example 10 | 0.150 | 0.90 | 50 | A | 1 | 3.26 | 0.24 | 0.03 |
| Example 11 | 0.150 | 0.91 | 50 | A | 1 | 3.27 | 0.25 | 0.03 |
| Example 14 | 0.050 | 0.95 | 50 | A | 1 | 3.33 | 0.29 | 0.03 |
| Comparative | The dope could not adhere to the support and film formation was impossible. | | | | | | | |
| Example 7 | | | | | | | | |
| Example 15 | 0.122 | 0.98 | 37 | A | 1 | 3.35 | 0.25 | 0.03 |
| Example 16 | 0.146 | 0.98 | 30 | A | 1 | 3.45 | 0.40 | 0.04 |
| Example 17 | 0.102 | 0.98 | 45 | A | 1 | 2.56 | 0.30 | 0.02 |
| Example 18 | 0.102 | 0.98 | 40 | A | 1 | 2.88 | 0.40 | 0.02 |
| Example 19 | 0.102 | 0.98 | 45 | A | 1 | 2.60 | 0.30 | 0.02 |
| Example 20 | 0.102 | 0.98 | 45 | A | 1 | 2.56 | 0.32 | 0.02 |
| Example 21 | 0.102 | 0.98 | 45 | A | 1 | 2.53 | 0.30 | 0.02 |

From the above Table 5, it is known that the cellulose acylate films obtained in Examples all had good recyclability, peelability and optical expressibility, and the haze thereof was low.

On the other hand, as in Comparative Example 1, when a cellulose acylate having a high degree of acyl substitution is contained in the cellulose acylate film in that embodiment, then the recyclability of the film was poor.

As in Comparative Example 2, when the amount added of the organic acid represented by the above-mentioned general formula (1) is less than 0.01% by mass of cellulose acylate, then the peeling load was high and the film could not be peeled smoothly.

As in Comparative Example 3, when the casting thickness of the support-side layer solution relative to the total casting thickness of the core layer solution and the support-side layer solution is less than the range in the production method of the invention, then the content of the organic acid of the general formula (1) was less than the range thereof to be in the film of the invention. In addition, it is known that the film peelability was poor and there occurred a problem in that the film peeled ununiformly in the dope casting direction and the film had peeling unevenness.

As in Comparative Example 4, when the amount of the organic acid of the general formula (1) added to the core layer solution is more than the range defined in the production method of the invention, then the amount of the organic acid added was larger than 1% by mass of cellulose acylate and, as a result, the optical expressibility of the film was poor and the haze thereof was high. Thus, the film is unsuitable as an optical film.

As in Comparative Example 5, it is known that, when the amount of the organic acid of the general formula (1) added to the support-side layer solution is more than the range defined in the production method of the invention, then the amount of the organic acid added was larger than the range thereof defined in the production method of the invention, and therefore the recyclability of the film was poor. The reason why the recyclability of the film worsens when the amount of the organic acid added is large would be because, the amount of the organic acid existing in the recovered film is large and therefore when the film chips are again dissolved to prepare a solution, then the amount of the organic acid increases therefore causing whitening of the formed film. However, the scope of the invention should not be restricted by the mechanism.

In Comparative Example 6, the organic acid was not added to the support-side layer solution but was added to only the air-side layer solution in film formation. Accordingly, in this, great resistance remained in peeling, and the film could not be smoothly peeled.

In Comparative Example 7, the organic acid solution in an amount over the amount defined in the invention was applied to the support, and then the cellulose acylate solution was applied thereonto. Therefore, in this, the cellulose acylate solution could not adhere to the support, and after dried, the film could not be formed.

Further, as in Comparative Example 8, it is known that, when the amount of the organic acid of the general formula (1) added to the support-side layer solution is larger than the range defined in the production method of the invention, then the amount of the organic acid added to the film was larger than that defined in the invention even though the organic acid was not added to the core layer solution, and as a result, the film was problematic in the recyclability thereof.

### Example 101

### Production of Polarizer

A stretched polyvinyl alcohol film was made to adsorb iodine to prepare a polarizing element.

Using a polyvinyl alcohol adhesive, the polarized film of Examples and Comparative Examples was stuck to one side of the polarizing element. The polarization condition was as follows: An aqueous solution of 1.5 mol/L sodium hydroxide was prepared and kept warmed at 55° C. An aqueous solution of 0.005 mol/L diluted sulfuric acid was prepared and kept warmed at 35° C. The produced cellulose acylate film was dipped in the aqueous sodium hydroxide solution for 2 minutes, and then dipped in water to fully remove the aqueous sodium hydroxide solution. Next, the film was dipped in the aqueous diluted sulfuric acid solution for 1 minute, and then dipped in water to fully remove the aqueous diluted sulfuric acid. Finally, the film was fully dried at 120° C.

A commercially-available cellulose triacetate film (Fujitac TD80UF by FUJIFILM) was saponified in the same manner as above, and using a polyvinyl alcohol adhesive, the thus-saponified film was stuck to the other side of the polarizing element and dried at 70° C. for 10 minutes or more. The polarizing element and the cellulose acylate film were so arranged that the transmission axis of the former could be parallel to the slow axis of the latter. The polarizing element and the commercially-available cellulose triacetate film were so arranged that the transmission axis of the former could be perpendicular to the slow axis of the latter.

### <Mounting on VA Panel>

As the viewers' side polarizer and the backlight side polarizer of a liquid crystal display device using a vertically aligned liquid crystal cell, used were the polarizer of Examples 1-14 and Comparative Examples and the polarizer having the commercial cellulose triacetate film (Fujitac TD80UF by FUJIFILM) on both sides of the polarizing element, respectively. The polarizer of Examples 15-21 were used on both sides of the liquid crystal cell. The viewers' side polarizer and the backlight side polarizer were stuck to the liquid crystal cell with an adhesive. These were so arranged that the transmission axis of the viewers' side polarizer could be in the vertical direction and the transmission axis of the backlight side polarizer could be in the horizontal direction, thus in cross-Nicol configuration.

The front contrast ratio of the thus-produced liquid crystal display device was measured. As a result, the liquid crystal display devices of the invention using the cellulose acylate film of Examples show good optical performance.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2011-68452 filed on Mar. 25, 2011 and Japanese Patent Application No. 2011-167532 filed on Jul. 29, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate film containing a cellulose acylate and an organic acid represented by the following general formula (1) in an amount of from 0.01% by mass to less than 1% by mass of the cellulose acylate, wherein at least 90% by mass of the cellulose acylate is a cellulose acylate having a total degree of acyl substitution of from 1.5 to 2.7:
X-L-(R¹)ₙ (1)
wherein X represents an acid group having an acid dissociation constant of at most 5.5; L represents a single bond or a lining group having two or more valence; R¹ represents a hydrogen atom, an alkyl group having from 6 to 30 carbon atoms, an alkenyl group having from 6 to 30 carbon atoms, an alkynyl group having from 6 to 30 carbon atoms, an aryl group having from 6 to 30 carbon atoms, or a heterocyclic group having from 6 to 30 carbon atoms, which may be further substituted; n is 1 when Lisa single bond but is (the valence of L-1) when L is a lining group having two or more valence.

2. The cellulose acylate film of claim 1, wherein X in the general formula (1) has at least one of a carboxyl group, a sulfonic acid group, a sulfinic acid group, a phosphoric acid group, a sulfonimide group and an ascorbic acid group.

3. The cellulose acylate film of claim 1, wherein L in the general formula (1) is a single bond, or a lining group having two or more valence selected from the following groups or a combination of these groups:
Groups: —O—, —CO—, —N(R²)— (where R² represents an alkyl group having from 1 to 5 carbon atoms), —CH(OH)—, —CH₂—, —CH═CH—, —SO₂—.

4. The cellulose acylate film of claim 1, wherein the organic acid represented by the general formula (1) has a structure where one molecule of a fatty acid and one molecule of a polycarboxylic acid bond to one molecule of a polyalcohol via ester-bonding, and has at least one unsubstituted carboxyl group derived from the polycarboxylic acid.

5. The cellulose acylate film of claim 1, wherein one face of the cellulose acylate film is called a face A and the other face thereof is a face B, and wherein the content of the organic acid existing in the depth of up to 2 μm from each surface of the face A and the face B, relative to the cellulose acylate, satisfies the following formula (I):
0.85≦Xa/Xb≦1.0 (I)
Xa≦Xb (I′)
wherein Xa means the organic acid content in the depth of up to 2 μm from the surface of the face A; and Xb means the organic acid content in the depth of up to 2 μm from the surface of the face B.

6. The cellulose acylate film of claim 1, which is formed through simultaneous or successive multilayer casting on a support and in which the organic acid is added to only the cellulose acylate solution to form the layer kept in contact with the support in casting.

7. The cellulose acylate film of claim 1, which has a total haze of at most 1% and has an internal haze of at most 0.1%.

8. The cellulose acylate film of claim 1, which has a thickness of from 20 to 60 μm.
